(19) United States
(12) Patent Application Publication
(10) Pub. No.: US 2025/0200608 A1
(43) Pub. Date: Jun. 19, 2025

(54) SEGMENT DISCOVERY AND CHANNEL DELIVERY

(71) Applicant: Adobe Inc., San Jose, CA (US)

(72) Inventors: Sunav Choudhary, San Jose, CA (US); Atanu R. Sinha, San Jose, CA (US); Harshita Chopra, San Jose, CA (US); Ryan A. Rossi, San Jose, CA (US); Veda Pranav Parwatala, Hyderabad (IN); Paavan Kumar Indela, Hyderabad (IN); Srinjayee Paul, San Jose, CA (US); Shunan Guo, San Jose, CA (US)

(73) Assignee: Adobe Inc., San Jose, CA (US)

(21) Appl. No.: 18/543,666

(22) Filed: Dec. 18, 2023

(51) Int. Cl. G06Q 30/0251

(52) U.S. Cl. CPC G06Q 30/0254

(57) ABSTRACT

Techniques for joint optimization of user segments and delivery channels are described. In one aspect, a method, includes obtaining activity data from a user device associated with a user, selecting, using a selector of a machine learning model, a user segment for the user based on the activity data, mapping, using a mapping function of the machine learning model, activity data for the user segment to features defined by multiple media channels, each media channel assigned a resource component, generating, using an objective predictor of the machine learning model, an objective prediction for the user segment based on the features and resource components of the media channels, the objective prediction identifying a media channel from the multiple media channels with a composite scalar metric above a defined threshold, and providing content to the user device via the media channel. Other embodiments are described and claimed.

### BACKGROUND

The following relates generally to machine learning, and more specifically to channel selection for content delivery. Content providers segment users into groups to deliver relevant content to similar people within each group. Formation of segments is the process of categorizing potential customers into these distinct groups based on shared characteristics, behaviors, and preferences. Segmentation methods include both rule-based methods and machine learning (ML) methods that learn the importance of various user attributes for group formation. These characteristics can include demographics, user device properties, and purchasing patterns. By understanding and segmenting users, organizations can convey content based on the specific characteristics and preferences of each user segment.

### SUMMARY

Embodiments generally relate to joint optimization of user segments and delivery channels to deliver content to the user segments subject to defined resource constraints. Embodiments include a content delivery system that obtains activity data from a user device associated with a user and sends content to the user device based on the activity data. Examples of activity data comprise interactions with digital media, such as posting social media messages, consuming multimedia content from a website, shopping for products or services from an electronic commerce storefront, and so forth. Examples of content comprise advertisements, recommendations, social media messages, and so forth. Embodiments are not limited to these examples.

As a user interacts with the digital media, a content delivery apparatus for the content delivery system obtains the activity data for a user over a session or defined time interval. The content delivery apparatus includes a machine learning (ML) model trained to receive as input the activity data for the user. The ML model predicts a target objective of a media channel and content delivered via the media channel. Examples of target objectives include without limitation reach, impressions, subscriptions, conversions, additions to cart, a number of repeat visits, or any other measures of interest for the user. Further, the ML model predicts the target objective given a defined resource constraint. The resource constraint defines an amount of resources allocated to achieving the target objective. Examples of resources include without limitation monetary resources, time resources, human resources, compute resources, memory resources, network resources, communication resources, device resources, opportunity resources, company resources, and any other finite resource. In some embodiments, the target objective and resource allocation are represented as a single combined scalar metric. The content delivery apparatus selects the media channel, based at least in part on the combined scalar metric, and it delivers content to the user device associated with the user.

In one embodiment, for example, the ML model receives activity data for the user as input, and it predicts a target objective such as a reach of a media channel. The reach of a media channel refers to a probability of the user being exposed to content via the media channel. For example, the ML model assigns the user to a user segment, transforms the activity data for the user to a set of features for media channels, and predicts a reach for the media channels to deliver content to the user segment that is optimized for a defined resource constraint. In one embodiment, for example, the resource constraint may comprise an allocation of monetary resources, such as a cost of reach as measured in financial terms, among other types of resources. The ML model recommends a media channel with acceptable levels of reach and cost of reach. In some embodiments, the reach and associated resource allocation are represented as a single combined scalar metric. The content delivery apparatus selects the media channel, based at least in part on the combined scalar metric, and it delivers content to the user device associated with the user.

In one embodiment, for example, the content delivery apparatus utilizes a first ML model that is optimized for multiple target objectives, such as a predicted conversion and the predicted reach of delivered content, subject to a resource constraint. The conversion of delivered content refers to a probability that a user becomes a buyer of a product or service of a company. For reach maximization subject to a resource constraint, embodiments use two different models. The first model is based on mean squared error (MSE). The second model is based on optimization under constraint. Since properties and characteristics of user segments are different from that of properties and characteristics used in a media space, a second ML model learns a mapping function to express a user segment in terms of a target objective, such as reach, conversion, impressions, subscriptions, and so forth. For example, the ML model uses a match rate and an exposure rate to make stochastic assignments to the media. The combination of the ML models result in optimized resource allocation for a given target objective, among other technical advantages. Other embodiments are described and claimed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a content delivery system in accordance with one embodiment.

FIG. 2 illustrates a message flow in accordance with one embodiment.

FIG. 3 illustrates a content delivery apparatus in accordance with one embodiment.

FIG. 4 illustrates a machine learning (ML) model in accordance with one embodiment.

FIG. 5 illustrates an operating environment in accordance with one embodiment.

FIG. 6 illustrates a system in accordance with one embodiment.

FIG. 7 illustrates a logic flow in accordance with one embodiment.

FIG. 8 illustrates a logic flow in accordance with one embodiment.

FIG. 9 illustrates a logic flow in accordance with one embodiment.

FIG. 10 illustrates an apparatus in accordance with one embodiment.

FIG. 11 illustrates convergence plots in accordance with one embodiment.

FIG. 12 illustrates an artificial intelligence architecture in accordance with one embodiment.

FIG. 13 illustrates an artificial neural network in accordance with one embodiment.

FIG. 14 illustrates a computer-readable storage medium in accordance with one embodiment.

FIG. 15 illustrates a computing architecture in accordance with one embodiment.

FIG. 16 illustrates a communications architecture in accordance with one embodiment.

### DETAILED DESCRIPTION

Embodiments generally relate to joint optimization of user segments and delivery channels based on one or more target objectives subject to one or more resource constraints. User segmentation, or user creation, is a form of data segmentation, which refers to the process of dividing a diverse dataset into smaller, more homogenous subsets. Techniques for segmentation include rule-based and ML-based techniques. Both techniques include identifying metrics or features that can be used to describe a user.

For example, user segmentation can be performed based on demographic features of the users (e.g., age, location, gender, browser type, etc.) or based on conversion data (e.g., whether delivered content had a desired impact). However, conventional segmentation methods do not consider content reach. In some cases, different users have access to different media channels, and content sent using a channel that a user does not have access to is less likely to reach the user. Accordingly, when users are segmented without considering the expected reach of the content, the delivery of the content can misalign with the users.

Conventional segmentation based on conversion data alone is insufficient for selecting an appropriate media channel or for segmenting users accessible via similar media channels because the media channel is only one of several factors that can influence a target objective, such as reach or conversion, for example. Importantly, conversion data is also influenced by the type of content. Therefore, content objective data can be useful in segmenting users because content reach is an indicator of the effectiveness of a media channel for delivering content.

One solution to this challenge is to include a ML model that is trained to optimize multiple target objectives simultaneously, such as predicted conversion and the predicted reach of delivered content, for example. To this end, some embodiments learn a mapping between user session data and a set of static characteristics which is used to predict both the conversion probability and the reach of the content. By jointly optimizing user segmentation for conversion and reach, the ML model performs more efficient content delivery as compared to existing user segmentation systems. This enables content providers to target more users within a user with their rendered content within a media channel.

However, this solution does not take into consideration resource constraints. The segmentation and delivery of content, such as messages to users, requires a certain amount of resources. As such, a message requestor typically engages a message provider to deliver messages under a specific resource allocation or resource constraint. A message requestor is any entity that requests delivery of messages to one or more users. A message provider is any entity that delivers the messages to the one or more users. A resource constraint comprises any defined level of resources allocated to accomplish measurable target objectives. Examples of message requestors and/or message providers include any defined entities, such as companies, organizations, governmental agencies, non-governmental agencies, educational institutions, message provider, advertising firms, social networking service providers, television broadcast companies, radio broadcast companies, digital streaming providers, electronic commerce websites, entertainment companies, and so forth. Embodiments are not limited to these examples.

For example, assume a message provider works under a resource constraint such as a budget constraint. A message provider can spend a media budget on various combinations of different user segments and different media. Different user segments, defined by static characteristics, result in different proportions of match and exposure, and these proportions differ across different media. Further, a cost of sending a message to a user varies by media. Thus, resource utilization depends on a composition of users in each user segment, those user's representation in static data which determines match and exposure proportions, and a resource consumption per medium. Consequently, segmentation is intrinsically linked to the delivery and the resource constraint (e.g., spend).

More particularly, online user activity enable message providers to perform user segmentation and deliver segment specific messages to users. It can be challenging, however, to deliver messages to users through effective media channels, such as social media websites owned by Meta® and Google®, among others. For example, only a portion of users in a user segment find a match in a medium, and only a fraction of those matched actually see the message, which is a concept referred to as “exposure.” Even high quality segmentation becomes futile when delivery fails. Many sophisticated algorithms exist for segmentation; however, these ignore the delivery component. The problem is compounded because: (i) the segmentation is performed on the behavior data space in a firms' data space (e.g., user clicks), while the delivery is predicated on the static data space (e.g., geo, age) as defined by media; and (ii) firms work under resource constraints.

The ubiquitous online user behavior data afford opportunities for user segmentation to online message providers. With ever more sophisticated algorithms, message providers leverage the data of its own users to analyze segments' propensities, behavioral tendencies, and other information to send messages, make predictions, offer recommendations, and improve users' experiences. User segments are fundamental blocks for message providers to target different segments with different messages and product and/or service offerings. Formation of segments, however, is only the first phase and it becomes ineffective unless messages can be actually delivered to the segments. Delivery of messages to the segment is the second phase.

Two uncertainties facing message providers pose challenges to delivery: (1) only a portion of a user segment finds match in a medium; and (2) only a fraction of those matched actually see the message, or has exposure to the message. In media parlance, when a message is sent to a segment, “reach” occurs provided both match and exposure are realized. Yet, even advanced ML algorithms for segmentation, unsupervised or supervised, ignore these uncertainties of reach inherent in delivery. Instead, those focus only on performance for segmentation while tacitly assuming away these delivery roadblocks. This is a significant challenge in the industry.

Message providers perennially face the problem of segmenting its users (or customers) for effective targeting, and allocating segments thus formed to different media within a resource constraint, such as a media budget, for example. When user segmentation is done independently of delivery considerations, however, messages are not efficiently or effectively delivered to a target segment. For example, assume a ML algorithm forms three user segments based on activity data, such as behavior data. As delivery with static data is decided, a typical outcome is that each segment gets mapped to multiple media. If the firm wants to deliver a message specifically aimed at a specific user segment, which is spread across two media, two problems arise. First, a resource constraint such as a budget constraint can be exceeded. Second, the message is delivered to some users in other user segments, which is a potential waste of resources. To avoid these and other problems, it would be prudent to account for delivery, during formation of segments, by considering alignment within the three media.

These and other considerations raise several technical challenges. A first challenge is to determine how to improve match across media with the goal of improving a target objective for delivering communication to users. A second challenge is to determine how to address the first challenge for endogenously formed users, as opposed to exogenously defined users, and multiple media. A third challenge is how to address the first challenge and the second challenge within a defined resource constraint, such as defined by money, time, or other finite resources. A fourth challenge is to determine how to also obtain high accuracy on a target objective, such as predicting conversion, reach, impressions, subscriptions, and so forth.

Achieving the dual goals of high target accuracy and maximization is compounded by two other factors. The first factor is the formation of user segments is performed on user activity data space (e.g., users' click, page visit, product viewed, etc.) which does not exist in the static data used by the media space. The media typically uses static data (e.g., geo, age, interests, etc.) on which the delivery is predicated. The second factor is that firms work under tight resource constraints associated with media channels.

Elaborating on the first factor, users' visits to a firm's website or application generate a user activity log of page uniform resource locators (URLs). This user activity is analyzed to determine which users are clustered into user segments, in a supervised or unsupervised manner. Activity data is considered dynamic data since it is always changing. For the same users, static data such as geography, age, and interests are available to the firm. When a firm ports over a user segment to a medium for sending messages to the user segment, the firm defines a set of static characteristics (e.g. country-us, age-35-40, interests-jazz) that “best” represents the user segment. Then this set, along with the message, are passed along to a medium, which does the delivery. The medium relies on static data to find users with (country-us, age-35-40, interests-jazz) from among the medium's vast user base.

One potential solution is for the firm to bypass the user segmentation step and instead form segments in the static data space. However, activity data is much more predictive of a user's decision (e.g. whether to convert, whether to renew a subscription) than static data, reinforcing the premium put on user segments. For effectiveness, it is necessary to maintain the primacy of user segmentation and map it to the static data for delivery.

Elaborating on the second factor, a message provider can spend available resources on various combinations of different user segments and different media. Different user segments, defined by their sets of static characteristics, result in different proportions of match and exposure, and these proportions differ across different media. Further, resources required for sending a message to a user varies by media. Thus, a firm's resource consumption depends on the composition of users in each user segment, those users' representation in static data, which determines match and the exposure proportions, and the resource consumption per medium. It follows that user segments is intrinsically linked to the delivery and resource consumption. However, conventional solutions miss this linkage.

To solve these and other challenges, embodiments implement techniques to jointly optimize user segmentation and media delivery based on one or more target objectives subject to one or more resource constraints. More particularly, embodiments introduce a stochastic optimization based algorithm to deliver optimized user segments and offer new metrics to address the joint optimization. Embodiments leverage optimization under a resource constraint for delivery combined with a learning-based component for segmentation. This approach simultaneously improves delivery metrics, reducing resource consumption, and achieving strong predictive performance in segmentation.

Embodiments include a content delivery system that obtains activity data from a user device associated with a user and sends content to the user device based on the activity data. Examples of activity data comprise interactions with digital media, such as posting social media messages, consuming multimedia content from a website, shopping for products or services from an electronic commerce storefront, and so forth. Examples of content comprise advertisements, recommendations, social media messages, and so forth. In one embodiment, for example, a certain type of activity data is referred to as “behavior data” which describes a certain behavior of the user when interacting with online content. However, other types of activity data exist as well. Embodiments are not limited in this context.

As a user interacts with the digital media, a content delivery apparatus for the content delivery system obtains the activity data for a user over a session or defined time interval. The content delivery apparatus includes a ML model trained to receive as input the activity data for the user. The ML model predicts a target objective of a media channel and content delivered via the media channel. Examples of target objectives include without limitation reach, impressions, subscriptions, conversions, additions to cart, a number of repeat visits, or any other measures of interest for the user. Further, the ML model predicts the target objective given a defined resource constraint. The resource constraint defines an amount of resources allocated to achieving the target objective. Examples of resources include without limitation monetary resources, time resources, human resources, compute resources, memory resources, network resources, communication resources, device resources, opportunity resources, company resources, and any other finite resource. In some embodiments, the target objective and resource allocation are represented as a single combined scalar metric. The content delivery apparatus selects the media channel, based at least in part on the combined scalar metric, and it delivers content to the user device associated with the user.

In one embodiment, for example, the ML model receives activity data for the user as input, and it predicts a target objective such as a reach of a media channel. The reach of a media channel refers to a probability of the user being exposed to content via the media channel. For example, the ML model assigns the user to a user segment, transforms the activity data for the user to a set of static characteristics for media channels, and predicts a reach for the media channels to deliver content to the user segment that is optimized for a defined resource constraint. In one embodiment, for example, the resource constraint may comprise an allocation of monetary resources, such as a cost of reach as measured in financial terms, among other types of resources. The ML model recommends a media channel with acceptable levels of reach and cost of reach. In some embodiments, the reach and associated resource allocation are represented as a single combined scalar metric. The content delivery apparatus selects the media channel, based at least in part on the combined scalar metric, and it delivers content to the user device associated with the user.

In one embodiment, for example, the content delivery apparatus utilizes a first ML model that is optimized for multiple target objectives, such as a predicted conversion and the predicted reach of delivered content, subject to a resource constraint. The conversion of delivered content refers to a probability that a user becomes a buyer of a product or service of a company. For reach maximization subject to a resource constraint, embodiments use two different models. The first model is based on mean squared error (MSE). The second model is based on optimization under constraint. Since properties and characteristics of user segments is different from that of properties and characteristics used in a media space, a second ML model learns a mapping function to express a user segment in terms of a target objective, such as reach, conversion, impressions, subscriptions, and so forth. For example, the ML model uses a match rate and an exposure rate to make stochastic assignments to the media. The combination of the ML models result in optimized resource allocation for a given target objective, among other technical advantages.

In one embodiment, for example, ML models are trained to perform joint optimization of user segmentation and delivery for user segmentation and optimize subject to a budget constraint. Embodiments generate metrics such as reach, a common currency for media spend, which maps to pay-per-click, pay-per-impression, pay-per-order, or other appropriate metrics. Embodiments may focus on direct media spend or programmatic advertiser bidding (ad-bidding) spend. For reach maximization subject to a resource constraint, two different forms are modeled: (1) based on mean squared error (MSE); and (2) based on optimization under constraint. In each form, embodiments present multiple models; totaling five proposed models. Further, since the space of behavior segments is different from that of static data, a separate network learns a mapping function, referred to herein as a behavior segment static representation (Beh2Stat). The mapping function allows a behavior segment to be expressed in terms of reach, through the match and exposure rates, to make stochastic assignments to the media. Five performance metrics are used to span conversion prediction, spend, and reach efficiency and effectiveness. Embodiments implement delivery aware discovery (DAD) models to produce predictive conversion accuracy, area under the receiver operating characteristic (AUROC) curve, comparable to models focused only on discovery (DISC), and yet reduces spend and increases reach. In addition, within the five proposed models, the Augmented Lagrangian stochastic optimization model has the best performance in closeness of spend to the budget, and in some cases performs better than that of the MSE based models.

Embodiments provide several technical advantages relatively to previous solutions. Embodiments focus on a direct media spend or a programmatic spend. Embodiments solve a new and unaddressed challenge of DAD in user segmentation. Embodiments propose a new model for joint optimization of segmentation and delivery, under a resource constraint. Embodiments recognize a mapping from a user activity data space to a media static data space since user segments are not realizable on media platforms. Embodiments perform stochastic optimization for the dual goals of: (a) predictive segmentation; and (b) optimizing a target objective (e.g., reach, conversion, impressions, subscriptions, etc.). When a target objective is reach and a resource constraint is a budget constraint, for example, embodiments introduce two new metrics for spend and reach efficacy, such as scalar-valued metrics referred to as “Effectiveness of Spend” and “Reach-Efficiency-Effectiveness”.

Consequently, embodiments support improved ML models for systems to deliver optimized user segmentation under a resource constraint. Embodiments simultaneously improve delivery metrics, optimize resource consumption, and achieve strong predictive performance in segmentation. Accordingly, this improves a speed and accuracy of an underlying compute system executing the ML models to implement improved user segmentation, user segment formation, media delivery, media selection, resource optimization, and media mix modeling, while consuming less compute cycles, memory resources, communication bandwidth, battery power, and other valuable resources associated with electronic systems.

In some examples, the systems described herein are deployed in connection with a social media platform. As a user interacts with the social media platform, their online activity is logged and converted into a user embedding. In some examples, the system assigns the user to a user segment, and pushes content through a channel determined by the user segment. In one example, the system places targeted content below a particular video on the social media platform. Because the system has segmented the user efficiently, the user is more likely to both view the video and see the targeted content, as well as to engage with the targeted content.

As used herein, “segments”, “users”, and “clusters” are used interchangeably to refer to a grouping of users based on user characteristics, attributes, or behaviors. In some cases, a segment of users is represented directly using a list, or indirectly by statistical aggregates such as a centroid representing a cluster of user embeddings.

As used herein, a “reach probability” or “reach prediction” is a likelihood of a user being exposed to content via a media channel. A reach prediction can be expressed as a product of a “match rate” and an “exposure rate”. The match rate reflects a matching of a user segment to a media channel. A user is “matched” to a media channel if they can be found in the media channel, e.g., if they belong to a social media platform, if they are in a certain geographic location, etc. If a user is not matched to a media channel, then any content delivered through that media channel will not be seen by the user. An exposure rate refers to whether a user, after having been matched to the media channel, sees or clicks the content delivered through that media channel. In some examples, the “reach prediction” includes both values predicted separately, or a product of both values.

As used herein, an “impression” refers to matching of a user or a user segment to a media channel. If a user is found in the media channel, but is not exposed after having been matched to the media channel, then this scenario is considered an impression. In some cases, impression can be realized by suppressing exposure.

As used herein, a “media channel” refers to any communication channel through which a user can be contacted or presented with content. A media channel can be general, such as a social media platform, or can be specific, such as a set of conditions that encompass users who use the social media platform and who are located within a geographic area, who use a particular device or application, etc. In some cases, the media channel is defined by a set of static characteristics such as geographic data, device data, environment data, and the like.

As used herein, “activity data” refers to a list of actions performed by a user over a time session window interacting with a media channel. For example, activity data can include a list of web pages visited by a user, email activity, any changes made to a user account, etc. In some examples, activity data is collected or grouped based on a given time period.

As used herein, “resource data” refers to any resources assigned by a message provider to a media campaign, media channel, message type, message, direct media spend, or user segment. Examples of resources include without limitation monetary resources, time resources, human resources, compute resources, memory resources, network resources, communication resources, device resources, opportunity resources, company resources, and any other finite resource.

As used herein, “budget data” refers to an amount of time, currency, or resources assigned by a message provider to a media campaign, media channel, message type, message, direct media spend, or behavior segment. For example, a message provider may assign a budget constraint in terms of United States Dollars (USD) per media channel (e.g., a social network or website) or behavior segment (e.g., users per clicks).

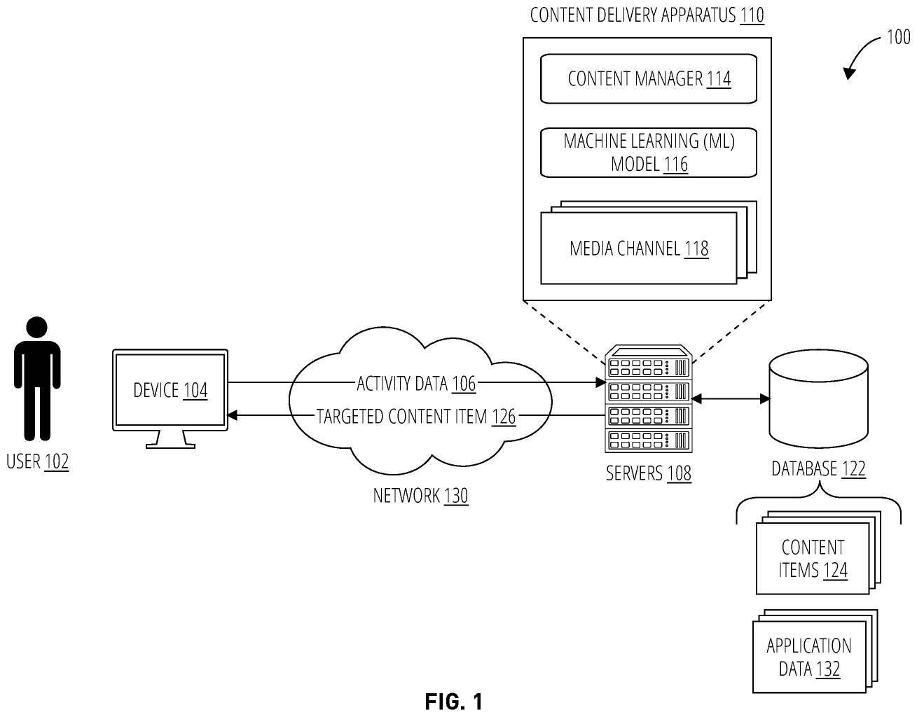

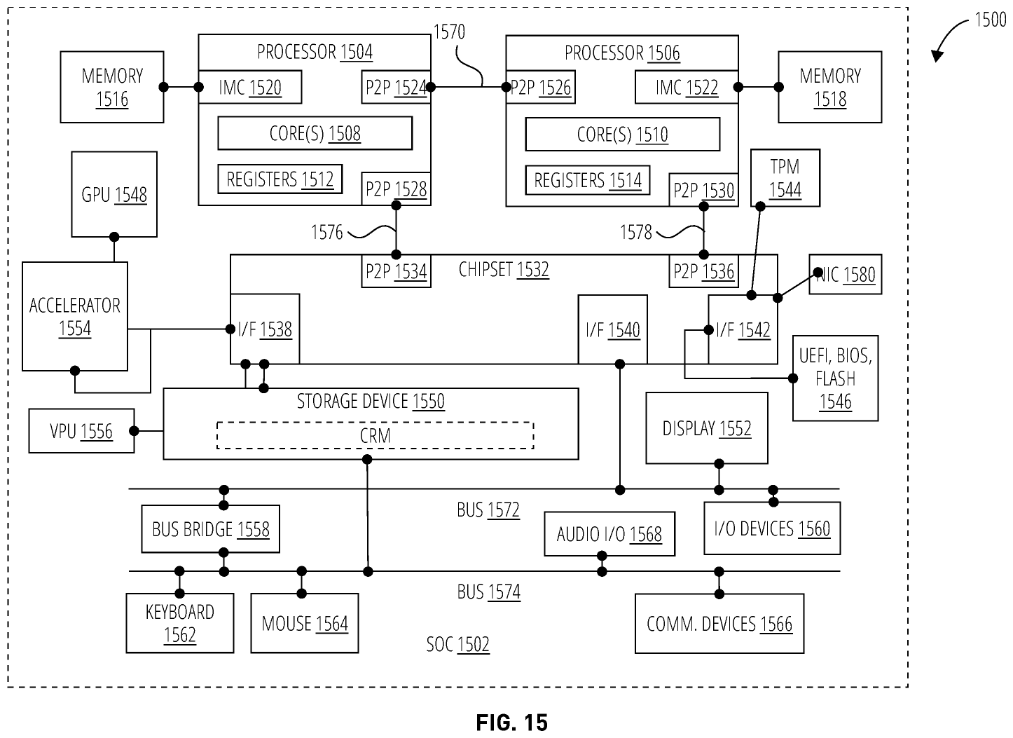

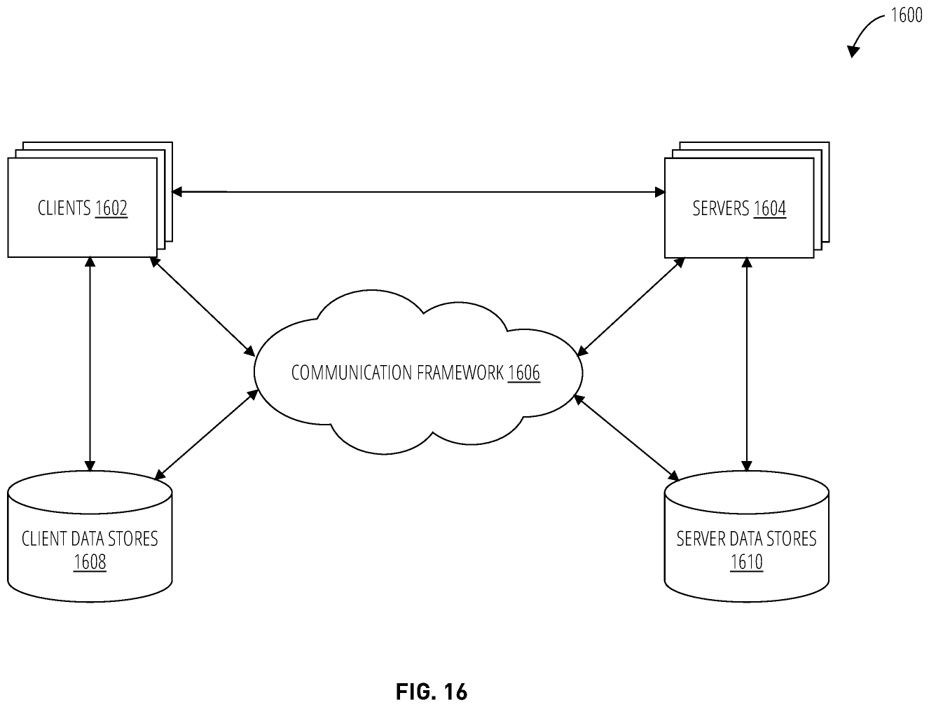

FIG. 1 illustrates a content delivery system 100. The content delivery system 100 is an example of a system designed to deliver targeted content to one or more users according to aspects of the present disclosure. The content delivery system 100 comprises a device 104, a set of one or more servers 108, and a database 122. The device 104 and the servers 108 may communicate information via a network 130. The device 104 may comprise an electronic device, such as a smartwatch, smartphone, tablet, laptop computer, desktop computer, and so forth. The servers 108 may be implemented as part of a data center, such as a cloud computing system. The device 104 and the servers 108 may be implemented using an architecture as described in FIG. 15. The network 130 may be implemented using an architecture as described in FIG. 16. Embodiments are not limited to these example implementations.

The one or more servers 108 implements a content delivery apparatus 110. In one embodiment, the content delivery apparatus 110 includes at least one processor; at least one memory including instructions executable by the at least one processor; and a machine learning model comprising parameters stored in the at least one memory, wherein the machine learning model comprises a selector configured to assign a user to a user segment, a reach predictor configured to predict content reach, and a cost predictor to predict cost per reach.

In some aspects, the machine learning model comprises an encoder configured to generate a user embedding vector, wherein the user is assigned to the user segment based on the user embedding vector. In some aspects, the encoder comprises a hierarchical attention network. In some aspects, the selector comprises a multi-layer perceptron (MLP). In some aspects, the machine learning model comprises a conversion predictor configured to predict a conversion rate for the user. In some aspects, the conversion predictor comprises an MLP. In some aspects, the reach predictor is configured to compute a representative static feature.

The servers 108 may include content delivery apparatus 110 designed for performing user segmentation and content delivery. In an example process, the content delivery apparatus 110 obtains activity data 106 from a user 102 via the device 104. The user 102 interacts with the content delivery apparatus 110 via a user interface of the content delivery apparatus 110. In some cases, portions of the user interface are displayed on a personal machine or device 104 of the user 102. The activity data 106 represents various actions, activities or behaviors of the user 102. For example, activity data 106 may represent data collected as the user 102 interacts with content items 124 of the database 122 served via the servers 108. Session data is any activity data 106 collected during a defined session time window, such as activity of the user over a 24 h period or some other time interval. For example, the user 102 may interact with the device 104 to communicate with content delivery apparatus 110 of one or more of the servers 108 to access one or more content items 124 stored by the database 122. The user 102 may perform various activities, such as browsing a web site, watching a streaming video, or engaging in electronic commerce. The session data, including the activity data 106, is transferred between the device 104 and the servers 108.

More particularly, the content delivery apparatus 110 comprises a content manager 114, an ML model 116, and data for one or more media channels 118. The content manager 114 coordinates operations for the content delivery apparatus 110. For example, the content manager 114 is responsible for creation of behavior-based user segments for users based on activity data and/or session data associated with the users, such as the activity data 106 for the user 102, for example. The content manager 114 then targets delivery of segment specific messages to users within the user segments, such as a targeted content item 126 for the user 102, over one or more media channels 118. The targeted content item 126 is a content item that is relevant to the user 102 or a user segment, such as messages, predictions, recommendations, advertisements, or suggestions to improve user experience.

The targeted content item 126 is delivered through one or more of the media channels 118. A media channel refers to a specific platform or medium through which targeted content, such as advertisements, are disseminated to a target user. Media channels 118 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market.

The content manager 114 forms user segments and delivery of segment specific messages for users through use of the ML model 116. The ML model 116 encodes the activity data 106 and/or the session data to generate or update a user embedding. The ML model 116 then assigns the user 102 to a cluster using a “selector” that assigns based on the user embedding. The ML model 116 generates a representative static feature for the cluster to which the user 102 is assigned. Finally, content delivery apparatus 110 delivers targeted content such as the targeted content item 126 to the user 102 by sending the targeted content item 126 through a media channel 118 assigned to the cluster. An example of the media channel 118 is a social media platform, such as Google or Meta, or some other mode of information transfer within the platform.

The content delivery apparatus 110 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 122 is an organized collection of data. For example, the database 122 stores data in a specified format known as a schema. The database 122 can be structured as a single database, a distributed database, multiple distributed databases, or an emergency backup database. In some cases, a database controller manages data storage and processing in database 122. In some cases, a user interacts with the database controller. In other cases, the database controller operates automatically without user interaction. The database 122 is configured to store various content items 124. The content items 124 include any multimedia information suitable for presentation by the device 104, such as HTML code to present websites, text, images, video, messages, advertisements, and so forth. In addition, the database 122 may store application data 132. The application data 132 comprises information and data used by the content delivery apparatus 110. For example, database 122 is configured to store user session data, profiles, embeddings, budgets, cached application programming interface (API) requests, machine learning model parameters, training data, and other data.

Network 130 facilitates the transfer of information between content delivery apparatus 110, database 122, and user 102. Network 130 is a computer network configured to provide on-demand availability of computer system resources, such as data storage and computing power. In some examples, the network 130 provides resources without active management by the user. The network 130 may include data centers available to many users over the Internet. Some large cloud networks have functions distributed over multiple locations from central servers. A server is designated an edge server if it has a direct or close connection to a user 102. In some cases, a cloud is limited to a single organization. In other examples, the cloud is available to many organizations. In one example, the network 130 includes a multi-layer communications network comprising multiple edge routers and core routers. In another example, the network 130 is based on a local collection of switches in a single physical location.

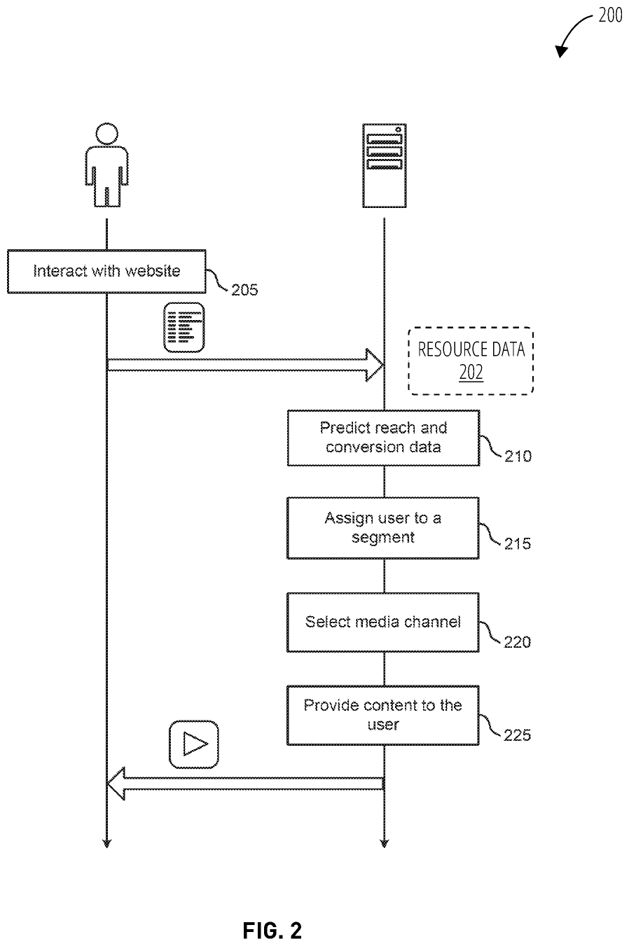

FIG. 2 shows an example of a message flow 200 for delivering content to users according to aspects of the present disclosure. Specifically, FIG. 2 illustrates an example of a user interaction with a system implementing content delivery apparatus 110. The system segments users based on both reach and conversion data, such as the content delivery apparatus 110 described with reference to FIG. 1. It includes operations performed by both a user and the content delivery apparatus 110. In this example, the system segments the user based on the user's interaction with a website, and provides content to the user based on the segmentation.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various sub-steps, or are performed in conjunction with other operations.

At operation 205, a user interacts with a website. In some examples, the website provides an interface to a platform, such as a social media platform. According to some aspects, the system records the user's interactions as activity data 106 over a defined time period, which is referred to as user session data. In some cases, a “session” corresponds to a time window, such as 24 hours, or some other time period. User session data includes, for example, the URLs of visited pages, email or message activity, or user edits to their profile.

In some examples, the system records data related to both reach data and conversion data. That is, the system records interactions that indicate whether a user interacts with content via a media channel, and whether the user performs a targeted action related to the content.

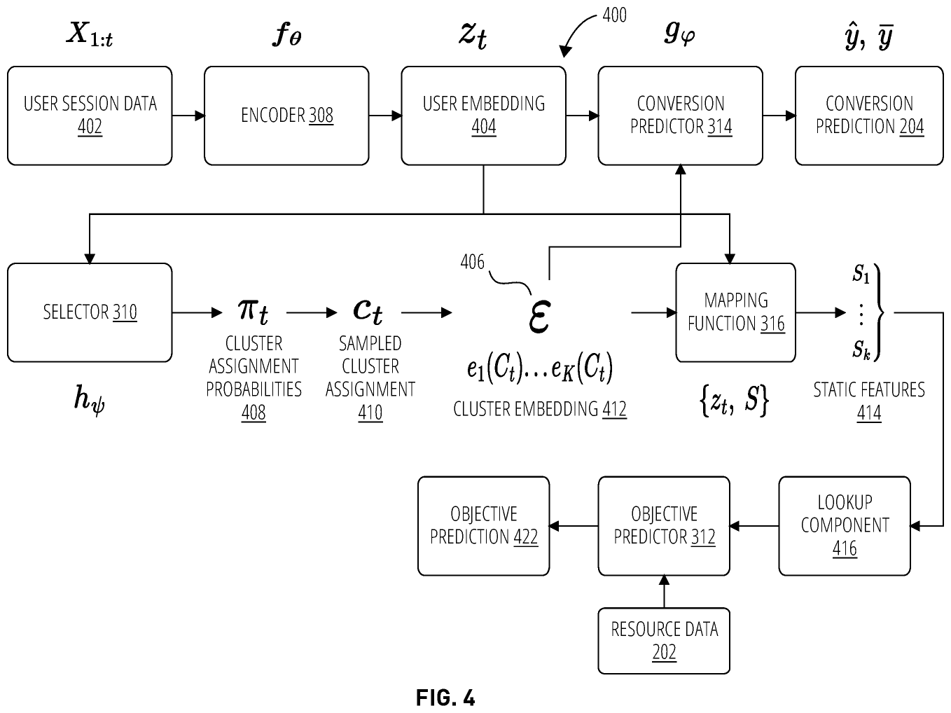

At operation 210, the system predicts reach data and conversion data for the user based on the user session data. In some examples, the predicted conversion data is a value that indicates whether the user is expected to click or respond to targeted content. In some examples, the predicted reach data includes a predicted match rate of the user to a media channel and a predicted exposure rate of the user to targeted content within that media channel. In one embodiment, the predicted reach data includes budget data. The system predicts the reach and conversion data using the ML model 116 in a process that will be described in additional detail with reference to FIG. 4.

At operation 215, the system assigns the user to a segment based on the user session data. In an example, the system encodes the user session data to generate a user embedding, and then processes the user embedding using a selector of the ML model 116 to assign the user to a user segment. In some embodiments, the selector outputs a probability distribution for the user over a set of existing segments. According to some aspects, the selector ensures that the user belongs to a segment with high probability, and that the segment is predicted to have a high conversion rate and a high content reach.

At operation 220, the system selects a media channel 118 for the user. In some embodiments, this operation includes predicting a set of static features for the user segment. In some examples, the media channel 118 is determined by the static features. For example, the static features can include values that define the media channel, such as a social media platform, a particular group or page within the platform, a geographic area, or similar.

At operation 225, the system provides content, such as one or more content items 124, to the user through the media channel 118. In some examples, the system delivers the content through the media channel 118 defined by the static feature that corresponds to the user segment.

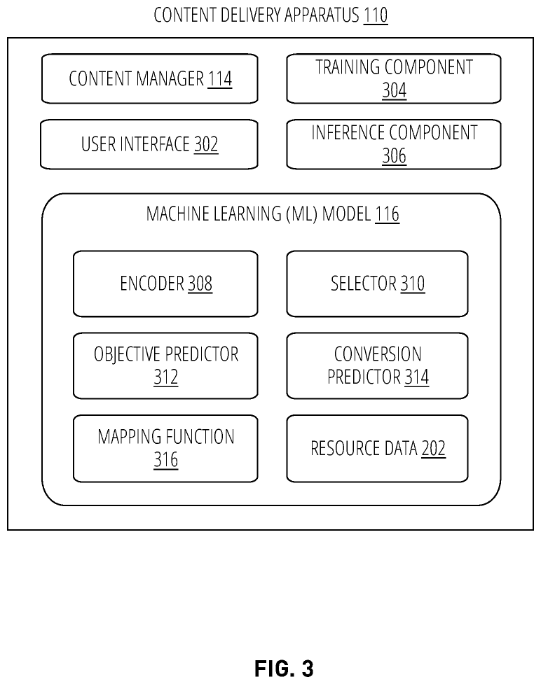

FIG. 3 shows an example of a content delivery apparatus 110 according to aspects of the present disclosure. The example shown includes content delivery apparatus 110, user interface 302, ML model 116, training component 304, and inference component 306. FIG. 3 illustrates an overview of the content delivery apparatus 110 and the components contained therein. Content delivery apparatus 110 is an example of, or includes aspects of, the corresponding element described with reference to FIG. 1.

Embodiments of content delivery apparatus 110 include several components and sub-components. These components are variously named and are described so as to partition the functionality enabled by the processors and the executable instructions included in the computing device used to content delivery apparatus 110, such as the computing device described with reference to FIG. 15. In some examples, the partitions are implemented physically, such as through the use of separate circuits or processors for each component. In some examples, the partitions are implemented logically via the architecture of the code executable by the processors.

User interface 302 is configured to receive input from and display content to a user 102. In some examples, user interface 302 includes a graphical user interface (GUI), which is implemented within a web-based application or standalone software. Additional detail regarding user interface component(s) will be described with reference to FIG. 15.

In one aspect, ML model 116 includes encoder 308, selector 310, objective predictor 312, conversion predictor 314, mapping function 316, and resource data 202. According to some aspects, ML model 116 comprises parameters and/or meta-parameters stored in at least one memory, e.g., a memory subsystem, wherein the ML model 116 is trained to assign a user to a user segment based on training data, such as content objective data and cost data, among other types of data. ML model 116 is an example of, or includes aspects of, the corresponding element described with reference to FIG. 4.

ML model 116 and its sub-components contain artificial neural networks (ANNs). The ANNs are used to generate embeddings of data, and to make classifications or predictions. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result, such as by minimizing a loss function which corresponds in some way to the difference between the current result and the target result. The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Encoder 308 is configured to process user session data to generate a user embedding. According to some aspects, encoder 308 generates a user embedding vector for the user based on the activity data 106, where the user 102 is assigned to a user segment based on the user embedding vector. Embodiments of encoder 308 include a hierarchical attention network (HAN). HANs are a type of ANN that include multiple layers that each include attention mechanisms to focus on different aspects of data. In some embodiments, a first level of attention in the HAN contains activities within a session, and a second level of attention encodes session-level information using a number of session windows. Encoder 308 is an example of, or includes aspects of, the corresponding element described with reference to FIG. 4. Embodiments are not limited to HAN encoders, and other suitable encoders may be implemented for the encoder 308 as well.

Conversion predictor 314 is configured to process a user embedding or a centroid embedding representing a cluster of users to predict a conversion result. Embodiments of conversion predictor include an ANN. According to some aspects, conversion predictor 314 generates a conversion prediction for the user segment, where the targeted content is provided based on the conversion prediction. According to some aspects, conversion predictor 314 computes a predicted conversion rate. Conversion predictor 314 is an example of, or includes aspects of, the corresponding element described with reference to FIG. 4.

In at least one embodiment, a HAN of encoder 308 is configured to generate a user embedding representing n session windows, and conversion predictor 314 is configured to receive the embedding and predict a result for the n+1 session of the user or the cluster centroid. This applies to data of a single session or when no session is demarcated in the user's log data. In this case the prediction is with respect to a future action in the user's sequence. In some embodiments, encoder 308 generates the embedding and the prediction. It may be appreciated that other types of encoders can be implemented for the encoder 308. Embodiments are not limited in this context.

In some aspects, the ML model 116 includes a selector 310 configured to assign the user 102 to the user segment. In some aspects, the selector 310 includes a multi-layer perceptron (MLP), which is a form of ANN. Embodiments of selector 310 process the user embedding and produce a distribution over a set of clusters. In some embodiments, selector 310 samples from the cluster distribution to assign the user corresponding to the user embedding to a cluster.

According to some aspects, selector 310 assigns the user 102 to a user segment based on the activity data 106 using ML model 116, where the ML model 116 is trained based on content objective data and cost data. Selector 310 is an example of, or includes aspects of, the corresponding element described with reference to FIG. 4.

In some aspects, the ML model 116 includes an objective predictor 312 configured to predict a target objective based on the user segment. Examples of target objectives include without limitation reach, impressions, subscriptions, conversions, additions to cart, a number of repeat visits, or any other measures of interest for the user. In one embodiment, for example, the objective predictor 312 is implemented as a reach predictor. However, the objective predictor 312 may be implemented as a predictor for any target objective. Embodiments are not limited to reach prediction.

Embodiments of the mapping function 316 generate a representative static feature for the user segment. In some examples, the static characteristics included in the representative static feature determine the content reach. In an example, a lookup component obtains content objective data using, for example, one or more API requests that include information from the representative static feature. The objective predictor 312 predicts the content reach to a user segment based, at least in part, on the representative static feature. Objective predictor 312 is an example of, or includes aspects of, the corresponding element described with reference to FIG. 4.

Training component 304 is configured to train or update ML model 116, including encoder 308, selector 310, objective predictor 312, conversion predictor 314, and mapping function 316. According to some aspects, training component 304 obtains result data for a user 102 or cluster of users. In some cases, the result data includes conversion result data and content objective data. Embodiments of training component 304 compute one or more loss functions, where the loss functions represent a discrepancy between the result data and prediction data. In some examples, training component 304 updates the ML model 116 based on the one or more loss functions.

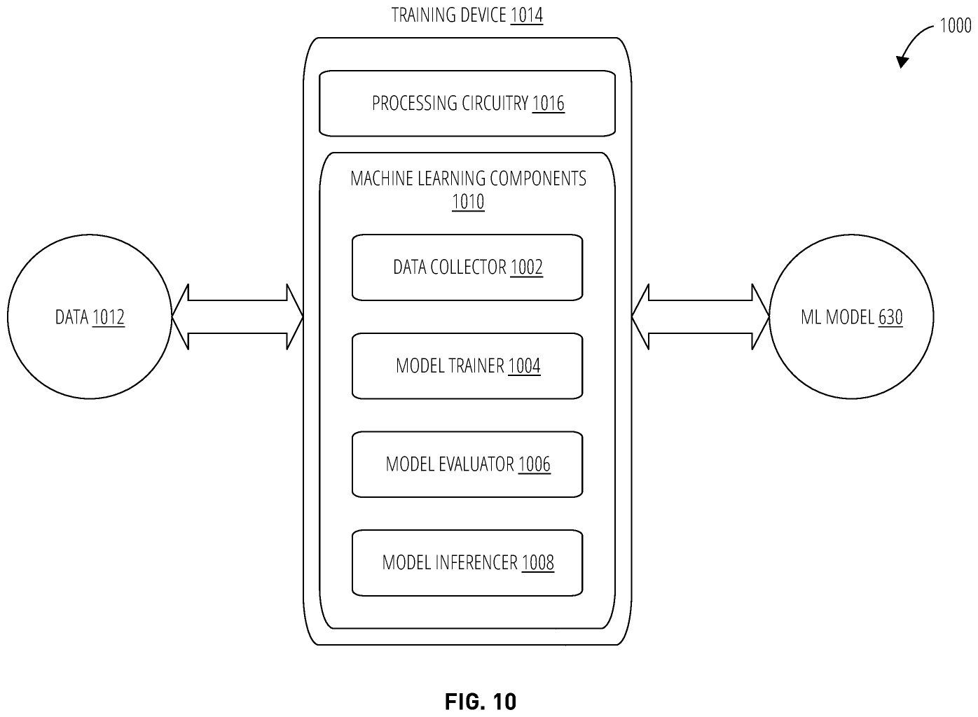

In some examples, training component 304 pre-trains an encoder 308, a conversion predictor 314, and a selector 310 of the ML model 116 in a first training phase. In some examples, training component 304 trains the encoder 308, the conversion predictor 314, and the selector 310 of the ML model 116 in a second training phase. In some examples, training component 304 trains the selector 310 and the objective predictor 312 of the ML model 116 in a third training phase. In some examples, training component 304 trains a mapping function 316 after the second training phase and before the third training phase. In at least one embodiment, training component 304 is provided by an apparatus other than content delivery apparatus 110. An example of the training component 304 is described in more detail with reference to FIG. 10 through FIG. 12.

In various embodiments, the activity data 106 for users comprises time stamped behavioral activity of users, for each user. For example, the activity data 106 comprises a website's pages (hereafter, page-urls), where the behaviors are captured in the format of page-urls. A user visits the site on multiple sessions, and in each session (visit) browses multiple pages. The logs show the time-stamped sequence of page-urls for each user as they click on pages, and are mapped to the user with an anonymized code. Additionally, each dataset has a binary target label for conversion, corresponding to each session. Statistics for the activity data 106 typically follows industry standard average number of pages per user, per session, ranging from 10 to 31. For the data at hand, behaviors are page-names in the form of page-urls, common for online browsing data. In other examples, such as campaign, behaviors can be open email, click email, unsubscribe, etc. Other target variables of interest to any firm can be used, including target variables with more than two classes.

Media data, such as data of match rate and exposure rate, are media dependent (e.g. different across different social media platforms (e.g., Meta, Google-YouTube, TikTok, etc.), and specific to the combination of static characteristics. For example, media data includes 5 static characteristics, (country, source, member-type, browser, os (operating system)). As an illustration, the 5-tuple, static characteristic set (country-us, source-bookmarked, member-frequent, browser-chrome, os-windows) has a match rate 0.56 and exposure rate 0.47 for a medium j; while for another 5-tuple (country-uk, source-bookmarked, member-infrequent, browser-edge, os-iOS) those values are 0.39 and 0.61 for the same medium j. However, in another medium j′, the former 5-tuple (country-us, source-bookmarked, member-frequent, browser-chrome, os-windows) has values 0.45 and 0.69. The match and exposure rates vary across the combinatorial set of static characteristics, for each medium. These data are available from a medium to the firm which advertises on the medium through reporting APIs, but are not typically publicly disclosed. To overcome this, a match rate and exposure rate is generated from a joint distribution over the support of the combinatorial set of static characteristics, which implies that for every combination (tuple) of the 5 static features, a match rate and an exposure rate, lying between 0.25 and 0.75 are drawn, for a medium. This is repeated for each medium. The match and exposure rates are held fixed for all the models. The cardinality of the set of 5-tuple static characteristics in this type of data is 1, 296. This results in a table of pairs of (match rate, exposure rate) for each 1, 296 five tuples and three media. From the social media data, embodiments use 6 static features, each categorized as follows: (medium [organic, referral/cpc/cpm, others]; deviceCategory [desktop, mobile/tablet]; operatingSystem [Macintosh/iOS, Windows, others]; categorized-geo [North America, Asia, Europe, others]; browser [Chrome, Safari and others]; source [direct, Google, others]). Match and exposure rates for the example data are generated in the manner as previously described. These static characteristics and their categories yield a table of 432 six tuples and three media, giving pairs of (match rate, exposure rate) for each of 432 six tuples, for each of three media.

Once the training component 304 trains the ML model 116, the inference component 306 may utilized the trained ML model 116 to infer, predict, suggest or recommend a set of outputs based on a given set of inputs. In one embodiment, for example, the trained ML model 116 may accept as input activity data 106 for the user 102, and it outputs a media channel for delivery of content to the user device 104 for the user 102 that maximizes both reach and spend parameters.

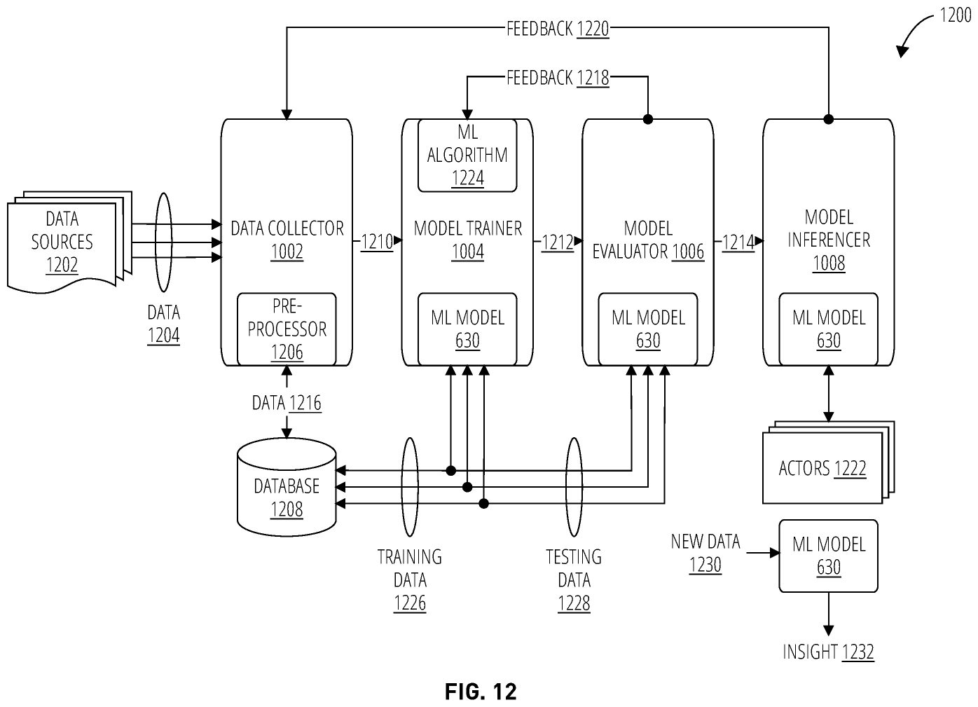

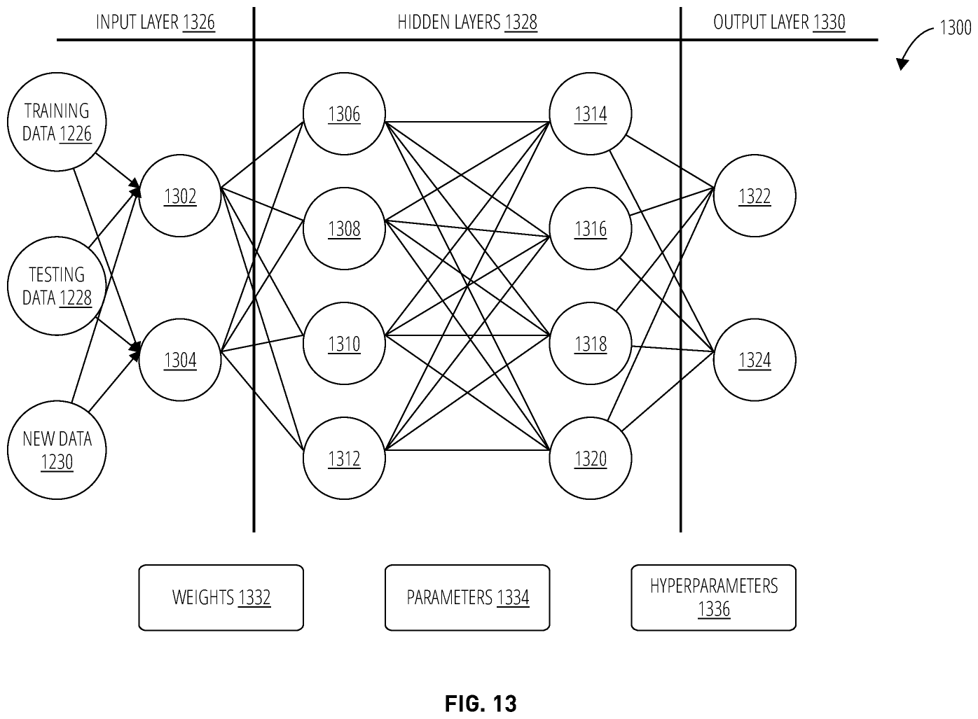

FIG. 4 illustrates a model architecture 400 for ML model 116 of the content delivery apparatus 110. The model architecture 400 is an example of a model architecture for user segmentation under a resource constraint, such as a budget constraint, for example. The model architecture 400 may be trained using the training apparatus 1000 and training system 1200 as described with reference to FIG. 10 and FIG. 12, respectively. The model architecture 400 may be implemented in an artificial neural network 1300 as described with reference to FIG. 13.

FIG. 4 shows an example of a machine learning model configured to perform joint optimization of user segmentation and delivery channels according to aspects of the present disclosure. The example is a new model for joint optimization of segmentation and delivery under a resource constraint, such as a budget constraint, for example. The example recognizes the mapping from an activity data space to a static data space since behavioral segments are not realizable on media platforms. The example performs stochastic optimization for dual goals of predictive segmentation and optimizing reach. The example introduces two new metrics for spend and reach efficiency.

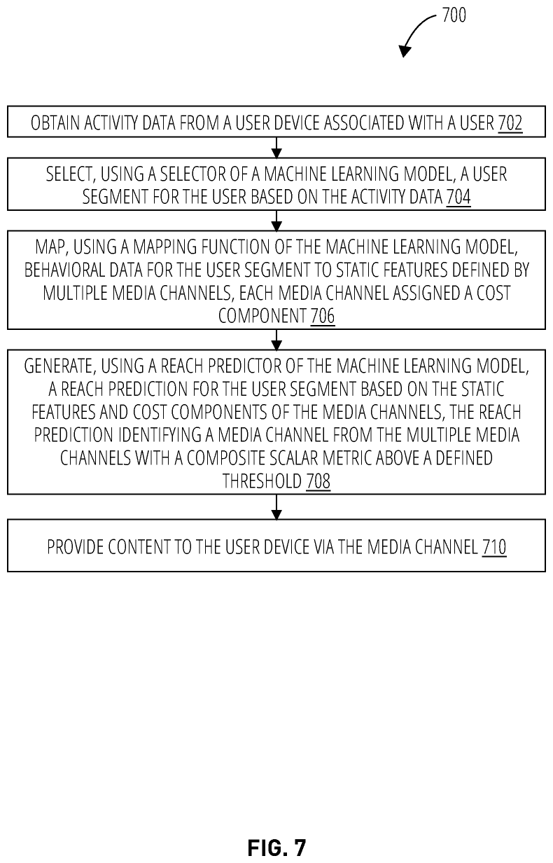

The model architecture 400 is designed to achieve joint optimization of (i) conversion prediction and (ii) reach maximization subject to a budget. In particular, to map activity data of users to static characteristics required by certain media, the model architecture 400 includes a custom mapping function, referred to herein as a behavior segment i static representation (Beh2Stat) function. The match rate and exposure rate vary by static characteristics and medium. The cost varies by medium. The Beh2Stat function's mapping to the static space, allows computation of cost of reach, which is then taken to the budget constraint. A training system to train the model architecture 400 to achieve the joint optimization is discussed in FIG. 7.

As depicted in FIG. 4, the model architecture 400 includes user session data 402, encoder 308, user embedding 404, conversion predictor 314, conversion prediction 204, selector 310, cluster assignment probabilities 408, embedding dictionary 406, cluster embedding 412, mapping function 316, static features 414, objective predictor 312, lookup component 416, objective prediction 422, and resource data 202. Encoder 308, conversion predictor 314, selector 310, objective predictor 312, mapping function 316, and resource data 202 are examples of, or include aspects of, the corresponding elements described with reference to FIG. 3.

Specifically, FIG. 4 illustrates an overview of how the ML model 116 uses user session data 402 to predict both a conversion prediction 204 and an objective prediction 422 for a user and to assign the user to a segment based on both aspects. In an example process, encoder 308 receives user session data 402 as input, and produces an intermediate user-level representation zₜ, also referred to as user embedding 404. User embedding 404 is a representation which embodies a latent behavioral tendency of a user.

The encoder 308 takes user behavior at time t as input represented by x_{1:t}={x₁, x₂, . . . , xₜ} for xₜ∈X, and learns to produce an intermediate user-level representation zₜ∈H, by predicting each user's target label, as in, ŷₜ. Note zₜ, a hidden vector in the latent space H, is a representation that embodies the latent tendency of a user, and is used for the clustering task. In one embodiment, the encoder 308 is a Hierarchical Attention Network (HAN). HAN encapsulates a two-level sequence of user behaviors. The first level is multiple pages browsed in each session. The second level is multiple sessions of each user. The first level encodes activities within each session to a session-level vector and the second level encodes the session-vectors to a user-level vector.

Conversion predictor 314 receives user embedding 404 as input and predicts an outcome, e.g., conversion prediction 204. Conversion predictor 314 is a fully connected network that takes an embedding z as input and predicts the target, e.g., conversion probability y. In some examples, conversion predictor 314 predicts a conversion ŷ for a user or a conversion y̅ for a cluster of users, depending on whether conversion predictor 314 processes a user embedding 404 zₜ representing a single user or an embedding e representing a cluster of users. According to some aspects, conversion predictor 314 is trained based on a comparison of the conversion prediction 204 to ground-truth conversion data, e.g., historical data. In at least one embodiment, encoder 308 and conversion predictor 314 are parts of the same connected network, where encoder 308 comprises input and intermediate layers, and conversion predictor 314 comprises a classification layer.

Selector 310 also receives user embedding 404 as input. Selector 310 is a fully connected network that takes a user embedding z as input and computes a distribution π where π(k) is the probability of the embedding z being assigned to the k-th cluster. Embodiments of selector 310 are configured to generate cluster assignment probabilities 408 based on user embedding 404. In some embodiments, selector 310 processes one or more user embeddings 404 to generate a cluster distribution πₜ. In some cases, an individual user's cluster assignment Cₜ is determined by selector 310 by sampling from the cluster distribution πₜ.

Some embodiments of the ML model 116 include embedding dictionary 406, as represented by ε. Embedding dictionary 406 is a dictionary of the centroids of K clusters. In some embodiments, embedding dictionary 406 is stored as a map of key-value pairs. For example, for a given sampled cluster assignment Cₜ, embedding dictionary 406 outputs cluster embedding 412, which is a centroid embedding e(Cₜ) that represents the entire cluster. Some embodiments of embedding dictionary 406 also store resource data 202, such as budget data represented as budget B, corresponding to a cost or expected cost of media delivered to the cluster.

Mapping function 316, referred to as Beh2Stat, is a fully connected network that learns a function mapping user behavioral embedding zₜ to the user static characteristics vector S∈S. Note that, by definition, static characteristics of a user do not depend upon t. Once trained, this function projects the i-th behavioral segment-specific centroid embedding e(cₜ)∈H to the i-th segment-specific static characteristics Sᵢ∈S. The projection is necessary to assign match rate ρᵢⱼ and exposure ηᵢⱼ to the i-th segment, since for any medium j, ρᵢⱼ and ηᵢⱼ are defined in terms of static characteristics Sᵢ, but not in terms of behavioral embedding. The ρᵢⱼ and ηᵢⱼ are used in the reach computation, defined later. Specifically, to preserve an important property, that the behavioral segment contains users with a variety of static characteristics, embodiments project a probability distribution p over the support of S and use that probability distribution to compute expected reach. This affords stochastic optimization of the objective, reach. The loss associated with Beh2Stat is given by L_{B}(ω)=−ΣS log p(S).

Objective function and constraints are defined as follows. For a behavioral segmentation objective, the input x_{1:t} are user behaviors present in the sequence of page URLs clicked. The output yₜ of a user denotes whether a conversion was observed or not. The objective of behavioral segmentation is to cluster users into segments based on users' embeddings zₜ such that segment-wise average prediction of conversion performs well. The following describes the training.

For a reach maximization objective, assume that each segment is assigned to only one medium (i.e., one media channel), but multiple segments can be communicated through the same medium. During training, an MLP vδ (S) learns to map static features to mediums. For i-th segment's static characteristics S, given a medium j, match rate and exposure rate coming from a table of match and exposure rates. The reach objective is denoted by L_{R} and is calculated as follows.

The loss, L₄, for the joint optimization of segmentation and delivery is shown in Equation (1), as follows:

$${ℒ}_{4} ( θ , ϕ , ψ , ω , δ ) = {ℒ}_{A} ( θ , ψ , ϕ ) + {ℒ}_{C} ( ϕ ) + {ℒ}_{R} ( δ ) \qquad ( 1 )$$

L_{R} denotes the loss for the reach maximization. Note that L_{R} changes with the specific formulation of the optimization's objective function. L_{A} denotes Actor loss and L_{C} denotes Critic loss, both of which are defined later.

Since each segment is activated on only one channel, the channel should be selected to maximize the reach of that segment. Hence, i-th segment's reach Rᵢ=maxⱼ(Aᵢⱼ ρᵢⱼηᵢⱼ). Expected total reach R is the sum of the reaches of individual segments and is given by Equation (2) as follows:

$$R = {\sum }_{i} {R}_{i} = {\sum }_{i} {max}_{j} ( {A}_{ij} {ρ}_{ij} {η}_{ij} ) {n}_{i} \qquad ( 2 )$$

The first form of reach maximization is based on Mean Squared Error (MSE). The total budget is split among the different media proportionate to the number of people it contains, which is the sum of the number of people in all segments assigned to that media. Depending upon match rate ρᵢⱼ, and exposure rate ηᵢⱼ of the static characteristic tuple of the segment to which the user belongs, the spend for reach differs across users in different segments and across different media. Note that (ρᵢⱼ, ηᵢⱼ) vary by static characteristic tuples and by media. Segments formed through the selector 310 yield the size nᵢ, for the i-th segment, where i=1, . . . , K, and K is the number of segments. The selector 310 yields the group of users in segment i, whose latent, segment-centroid embedding Er is passed to the mapping function 316 (Beh2Stat), which outputs i-th segment's static characteristics tuple. Given this tuple, corresponding (ρᵢⱼ, ηᵢⱼ) for each medium j are read from a table for segment i. For MSE, per individual user in segment i, medium j, the expected reach=ρᵢⱼηᵢⱼ. Per individual user assigned to medium j, the reach goal=B/N χj. The intuition is that with N users, and cost per user reached χj, the budget B is divided into a reach goal per user. Two variations of MSE are modeled as loss functions and described below.

For a Cluster Specific Reach MSE, a loss is defined per cluster and the back propagation is per cluster. The loss for i-th cluster is expressed in Equation (3), as follows:

$${ℒ}_{R} = {\sum }_{j} {{A}_{ij} ( {ρ}_{ij} {η}_{ij} - B / {N}_{{χ}_{i}} )}^{2} \qquad ( 3 )$$

For Cluster Agnostic Reach MSE, the loss is averaged across all clusters, and the back propagation is across all clusters. The MSE is expressed in Equation (4), as follows:

$${ℒ}_{R} = \frac{{\sum }_{i} {\sum }_{j} {A}_{ij} {n}_{i} * {( {ρ}_{{s}_{ij}} {η}_{{s}_{ij}} - B / {N}_{{χ}_{i}} )}^{2}}{{\sum }_{i} {n}_{i}} \qquad ( 4 )$$

For budget constraint, let j′≙arg maxⱼ (Aᵢⱼρᵢⱼηᵢⱼ) be the channel which maximizes Rᵢ for any given segment i. The budget constraint for total reach is expressed in Equation (5), where the second term in Equation (5) is the Spend, as follows:

$${T}_{R} = B - {\sum }_{i} ( {A}_{ij ′} {ρ}_{ij ′} {η}_{ij ′} ) {χ}_{j ′} {n}_{i} \geq 0 \qquad ( 5 )$$

Objective predictor 312 receives a cluster embedding 412 (i.e., a centroid embedding), static features 414, and resource data 202, and it produces an objective predictor 312 for the cluster.

Lookup component 416 determines an objective prediction 422 for the cluster corresponding to static features 414 via a data lookup operation. For example, in some embodiments, a match rate of users in an i-th cluster to a j-th media channel is given by pᵢⱼ. A match rate is the proportion of the cluster that is found in the media channel. An exposure rate is the proportion of matched users in the cluster who click or interact with the media sent in the media channel, and is given by nᵢⱼ. Content reach is a measure of users who are both 1) matched in the media channel and 2) interact with the media, and is given by the product of the two rates, pᵢⱼnᵢⱼ. Lookup component 416 references a table or otherwise obtains the content objective data pᵢⱼnᵢⱼ for set of static characteristics included in static features 414, such as demographics, browser/device data, or the like.

Objective predictor 312 learns a mapping between a cluster embedding 412, which represents activity data for a group of users, to static features 414, which is used to predict content reach as described above. Connecting all of the components, ML model 116 learns to generate user and cluster embeddings that result in user segmentation that both: (1) maintains accuracy of conversion prediction; and (2) maximizes reach of targeted media for a given budget constraint.

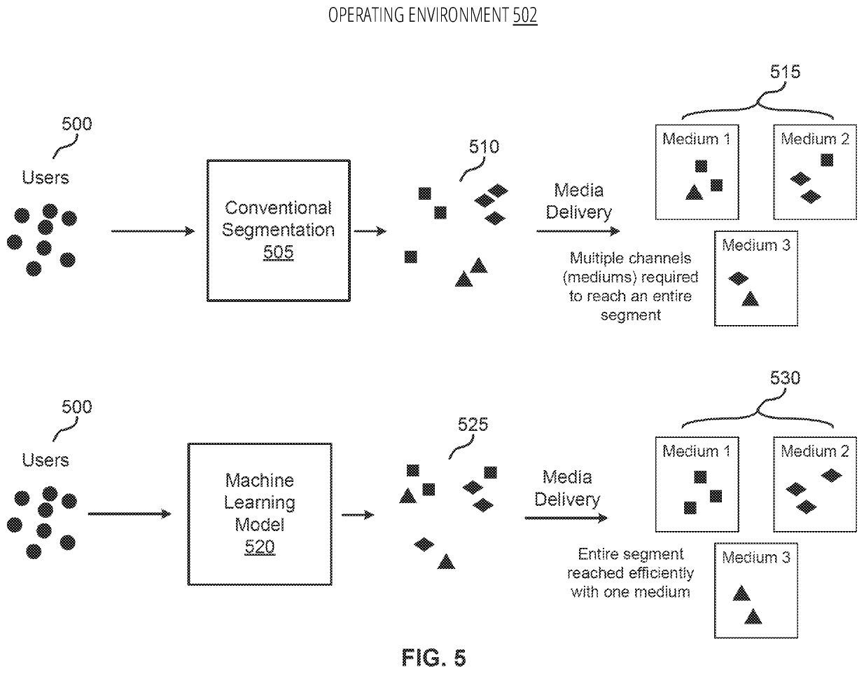

FIG. 5 shows an example of media delivery using conventional segmentation versus an example of media delivery using delivery aware segmentation according to aspects of the present disclosure. The example shown includes users 500, conventional segmentation 505, first classified users 510, media channels including first classified users 515, machine learning model 520, second classified users 525, and media channels including second classified users 530. Machine learning model 520 is an example of, or includes aspects of, the ML model 116 as described with reference to FIG. 4.

FIG. 5 illustrates an example of how conventional segmentation 505 generates user segments that result in inefficient content delivery. In some cases, using convention user segmentation methods (e.g., methods based on demographics or conversion data), a given segment (represented by different shapes such as squares or triangles) must be reached using multiple media channels. However, using a machine learning model trained for delivery aware segmentation, a single segment can be reached using a smaller number of channels (sometimes using a single channel as depicted).

FIG. 5 further illustrates an example of segmentation performed by a machine learning model according to the present embodiments, which generates segments that can be efficiently reached by each segment's assigned media channel (e.g., medium).

In a comparative example, users 500 are grouped using conventional segmentation 505. Conventional segmentation 505 groups users in a phase that does not consider media delivery. For example, some conventional techniques include a research phase to create dimensions for a user based on market research or heuristics. Then, each user is assigned to a segment based on the user's values in the dimensions. Other techniques include machine learning techniques that try to group users based on a high predicted conversion rate using embeddings, but do not consider the reach of the content when creating the embeddings.

Conventional segmentation 505 produces first classified users 510, e.g. “users”, which includes a set of labels for each of the users 500. However in some cases, the media is misaligned with the users. As shown by media channels including first classified users 515, one medium or media channel reaches only a subset of each user, rather than having an efficient overlap with the user. In some cases, this is due to the conventional segmentation which focused on high predicted conversion rates for individual users, and which neglected to consider the effectiveness of content delivery to the entire user.

By contrast, users segmented using embodiments of the present disclosure such as machine learning model 520 are better aligned. For example, second classified users 525 are segmented such that the available media channels reach each of the segments with increased accuracy. In this simplified example, media channels including second classified users 530 includes a media channel for each segment that reaches the entire segment. In this way, a content provider can use a lower budget; they would not need to employ two or more media channels to reach an entire user.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

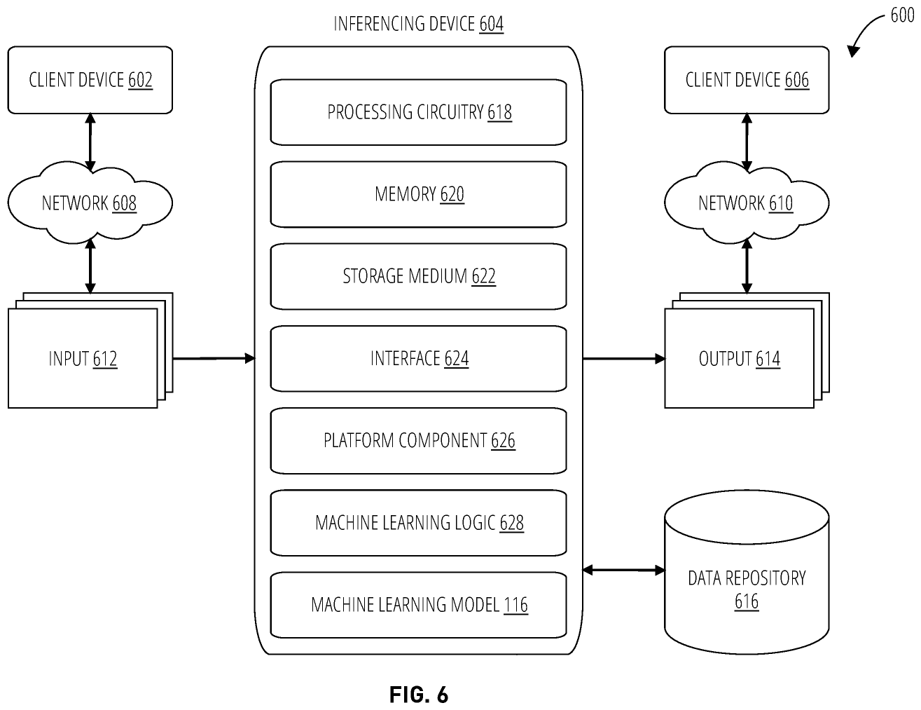

FIG. 6 illustrates an embodiment of a system 600. The system 600 is suitable for implementing one or more embodiments as described herein. In one embodiment, for example, the system 600 is an AI/ML system suitable for performing content delivery operations for the content delivery system 100 and/or the content delivery apparatus 110.

The system 600 comprises a set of M devices, where M is any positive integer. FIG. 6 depicts three devices (M=3), including a client device 602, an inferencing device 604, and a client device 606. The inferencing device 604 communicates information with the client device 602 and the client device 606 over a network 608 and a network 610, respectively. In one embodiment, for example, the inferencing device 604 comprises a server device that implements the ML model 116 for the content delivery apparatus 110. The client device 602 and the client device 606 are devices that implement a GUI interface, such as a web browser, to remotely access content delivery services offered by the inferencing device 604. In one embodiment, for example, the inferencing device 604 is a client device 602 or the client device 606, such as a smartphone, tablet, laptop computer or desktop computer, that executes a GUI to directly interact with the content delivery apparatus 110 executing locally on the inferencing device 604.

The information includes input 612 from the client device 602 and output 614 to the client device 606, or vice-versa. An example of the input 612 is a user session data 402. An example of the output 614 is content comprising one or more content items 124 delivered over a media channel 118 via the network 608 and/or the network 610. In one alternative, the input 612 and the output 614 are communicated between the same client device 602 or client device 606. In another alternative, the input 612 and the output 614 are stored in a data repository 616. In yet another alternative, the input 612 and the output 614 are communicated via a platform component 626 of the inferencing device 604, such as an input/output (I/O) device (e.g., a touchscreen, a microphone, a speaker, etc.).

As depicted in FIG. 6, the inferencing device 604 includes processing circuitry 618, a memory 620, a storage medium 622, an interface 624, a platform component 626, ML logic 628, and an ML model 116. The ML logic 628 executes operations to support the content delivery apparatus 110. In some implementations, the inferencing device 604 includes other components or devices as well. Examples for software elements and hardware elements of the inferencing device 604 are described in more detail with reference to a computing architecture 1500 as depicted in FIG. 15. Embodiments are not limited to these examples.

The inferencing device 604 is generally arranged to receive an input 612, process the input 612 via one or more AI/ML techniques, and send an output 614. The inferencing device 604 receives the input 612 from the client device 602 via the network 608, the client device 606 via the network 610, the platform component 626 (e.g., a touchscreen as a text command or microphone as a voice command), the memory 620, the storage medium 622 or the data repository 616. The inferencing device 604 sends the output 614 to the client device 602 via the network 608, the client device 606 via the network 610, the platform component 626 (e.g., a touchscreen to present text, graphic or video information or speaker to reproduce audio information), the memory 620, the storage medium 622 or the data repository 616. Examples for the software elements and hardware elements of the network 608 and the network 610 are described in more detail with reference to a communications architecture 1600 as depicted in FIG. 16. Embodiments are not limited to these examples.

The inferencing device 604 includes ML logic 628 and ML model 116 to implement various AI/ML techniques for various AI/ML tasks. The ML logic 628 receives the input 612, and processes the input 612 using the ML model 116. The ML model 116 performs inferencing operations to generate an inference for a specific task from the input 612. In some cases, the inference is part of the output 614. The output 614 is used by the client device 602, the inferencing device 604, or the client device 606 to perform subsequent actions, such as downstream tasks, in response to the output 614.

In various embodiments, the ML model 116 is a trained ML model 116 using a set of training operations and training data. An example of training operations to train the ML model 116 is described with reference to FIG. 10.

FIG. 7 illustrates an embodiment of a logic flow 700. The logic flow 700 is representative of some or all of the operations executed by one or more embodiments described herein. For example, the logic flow 700 includes some or all of the operations performed by devices or entities within the content delivery system 100, the content delivery apparatus 110, the ML model 116, the message flow 200, the model architecture 400, or the operating environment 502. In one embodiment, the logic flow 700 is implemented as instructions stored on a non-transitory computer-readable storage medium 622 that when executed by processing circuitry 618 causes the processing circuitry 618 to perform the described operations. The storage medium 622 and processing circuitry 618 may be co-located, or the instructions may be stored remotely from the processing circuitry 618. Collectively, the storage medium 622 and the processing circuitry 618 may form a system.

In block 702, logic flow 700 obtains activity data from a user device associated with a user. In block 704, logic flow 700 selects, using a selector of a machine learning model, a user segment for the user based on the activity data. In block 706, logic flow 700 maps, using a mapping function of the machine learning model, activity data for the user segment to static features defined by multiple media channels, each media channel assigned a resource component. In block 708, logic flow 700 generates, using a reach predictor of the machine learning model, a reach prediction for the user segment based on the static features and resource components of the media channels, the reach prediction identifying a media channel from the multiple media channels with a composite scalar metric above a defined threshold. In block 710, logic flow 700 provides content to the user device via the media channel.

By way of example, with reference to the content delivery apparatus 110, the content manager 114 obtains activity data 106, such as user session data 402, from a user device 104 associated with a user 102. The content manager 114 feeds the activity data 106 as input into the ML model 116. The ML model 116 comprises a joint optimization of segmentation and delivery for user segmentation and optimize subject to the media spend budget constraint. ML model 116 addresses metrics such as reach, a common currency for media spend, which maps to pay-per-click. For reach maximization subject to a budget, two different forms are modeled: (1) based on mean squared error (MSE); and (2) based on optimization under constraint. The ML model 116 is trained using content objective data and resource data 202.

The selector 310 of the ML model 116 selects a user segment, such as sampled cluster assignment 410, for the user 102 based on the activity data 106. The objective predictor 312 generates an objective prediction 422 for the user segment. In one embodiment, the objective prediction 422 includes a media channel 118 that maximizes a reach for the user segment subject to a budget constraint as defined by the resource data 202. The reach is a product of a match rate and an exposure rate associated with the set of static features 414 for the user segment and a budget constraint obtained from the resource data 202. The budget constraint includes a total spend budget for a plurality of media channels 118 for the user segment. The content manager 114 selects the media channel 118 based on the objective prediction 422. The content manager 114 provides content in the form of one or more content items 124 to the user device 104 via the selected media channel 118. Examples of content items 124 may include a textual message, an audio message, a video message, an advertisement, a service offering, or any other types of content.

The mapping function 316 maps activity data for the user segment to static features 414 defined by multiple media channels 118, each media channel 118 assigned a resource component from the resource data 202. Since the space of behavior segments is different from that of static data, a separate network learns a mapping function 316, referred to as Beh2Stat, such that a behavior segment can be expressed in terms of reach, through the match and exposure rates, to make stochastic assignments to the media channel 118. To this end, the ML model 116 includes a mapping function 316 for generating a set of static features 414 for the user segment. The set of static features 414 are associated with the media channel 118. In one embodiment, the static features 414 are static characteristics for the user 102 or a group of users in a user segment, such as a geographical location, an age, a gender, demographic information, interests, hobbies, and so forth. The mapping function 316 transforms the dynamic behavioral characteristics for the user 102 as reflected by the activity data 106 and encoded into the user embedding 404 into the static features 414 used by message provider to select media channels 118.

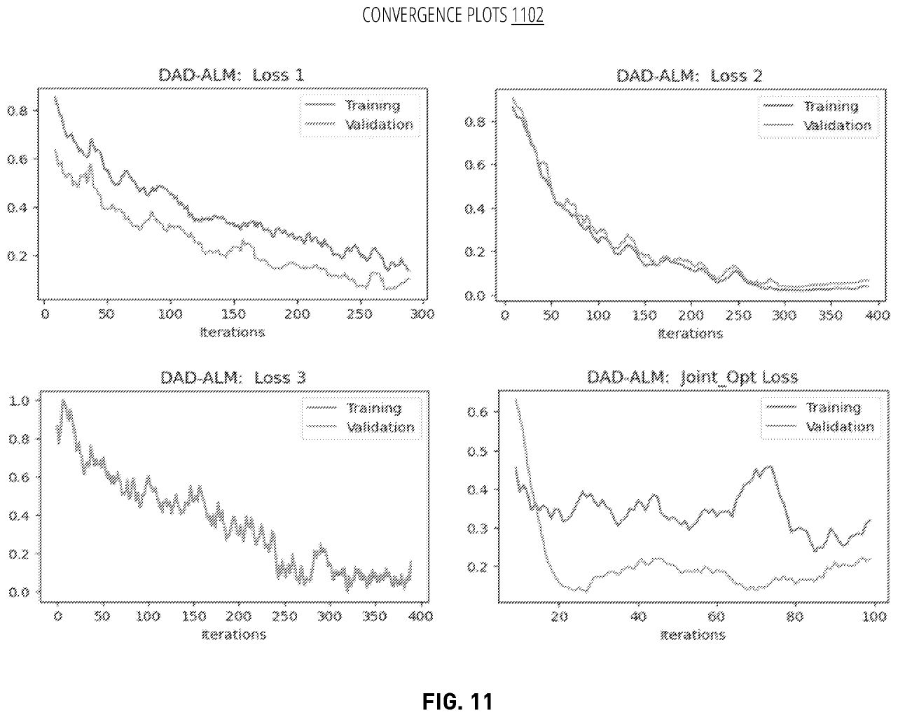

The ML model 116 also includes an objective predictor 312 for generating an objective prediction 422 for the user segment based on the static features 414 and resource components of the media channels 118. In one embodiment, the objective prediction 422 identifies a media channel 118 from the multiple media channels 118 with a composite scalar metric above a defined threshold. In one embodiment, for example, the composite scalar metric includes an effective resource consumption metric that combines a first metric representing predictive target accuracy and a second metric representing resource consumption per unit objective. In one embodiment, for example, the composite scalar metric includes a reach efficiency-effectiveness metric that combines a first metric representing reach-efficiency and a second metric representing accuracy of prediction. The effective resource consumption metric and the reach-efficiency-effectiveness metric are described in more detail with reference to FIG. 11.

The ML model 116 also includes a conversion predictor 314 for generating a conversion prediction 204 for the user segment, where the content items 124 are provided based on the conversion prediction 204.

The ML model 116 also includes an encoder 308. The encoder 308 receives the activity data 106, such as user session data 402, for the user 102 to obtain a user embedding 404 for the user 102. The user embedding 404 comprises a behavioral embedding. In one embodiment, the encoder 308 of the ML model 116 is implemented as a hierarchical attention network (HAN) encoder 308. The HAN encoder 308 encodes the activity data 106 for the user within a session to a session-level vector and the session-level vector to the user embedding 404 for the user 102.

The content manager 114 selects the media channel 118 based on the objective prediction 422 subject to the budget constraint. The content manager 114 generates a targeted content element, such as targeted content item 126, based on the media channel 118 that maximizes reach for the user segment. The content manager 114 delivers the content over the media channel 118 as targeted content item 126 via the network 130.

The user device 104 receives the targeted content item 126. The user device 104 presents the targeted content item 126 on a GUI of an electronic display of the client device 104. The user 102 may use the GUI to interact with the targeted content item 126, such as selecting a video to play or clicking an advertisement to learn more about a product or service.

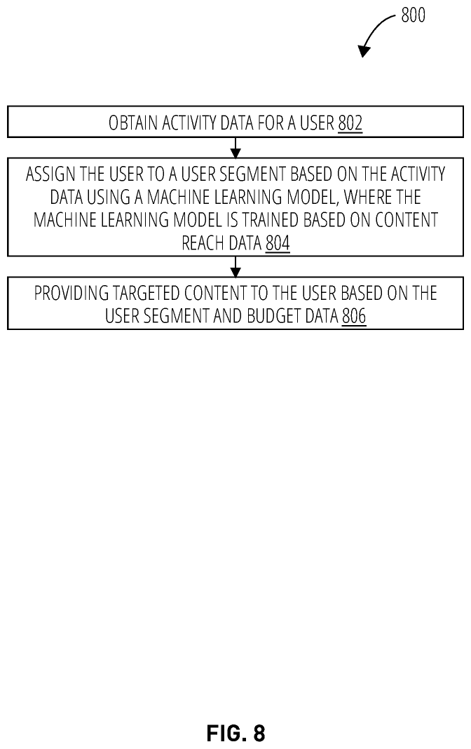

FIG. 8 illustrates a logic flow 800. Logic flow 800 shows an example of a method for providing targeted content to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various sub-operations, or are performed in conjunction with other operations.

In block 802, logic flow 800 obtains activity data for a user. In block 804, logic flow 800 assigns the user to a user segment based on the activity data using a machine learning model, where the machine learning model is trained based on content objective data and budget data. In block 806, logic flow 800 providing targeted content to the user based on the user segment and budget data.

More particularly, at block 802, the system obtains activity data 106 for a user 102. In some cases, the operations of this block refer to, or are performed by, a content delivery apparatus 110 as described with reference to FIG. 1 and FIG. 3. In an example, the system records user session data based on a user's activity on a website.

At block 804, the system assigns the user 102 to a user segment based on the activity data 106 using a machine learning model, such as ML model 116, where the machine learning model is trained based on content objective data and resource data 202. In some cases, the operations of this block refer to, or are performed by, a selector 310 as described with reference to FIG. 3 and FIG. 4. For example, an encoder 308 of the ML model 116 generates a user embedding 404, and the selector 310 assigns the user 102 based on the user embedding 404 according to the process described with reference to FIG. 4.

At block 806, the system provides targeted content, such as targeted content item 126, to the user 102 based on the user segment and resource data 202. In some cases, the operations of this block refer to, or are performed by, a content delivery apparatus 110 as described with reference to FIG. 1 and FIG. 3. In an example, a mapping function 316 generates a representative static feature for the user segment as described with reference to FIG. 4, the objective predictor 312 predicts a media channel 118 based on reach and budget, and the content delivery apparatus 110 then sends targeted content via a media channel 118 associated with the representative static feature.

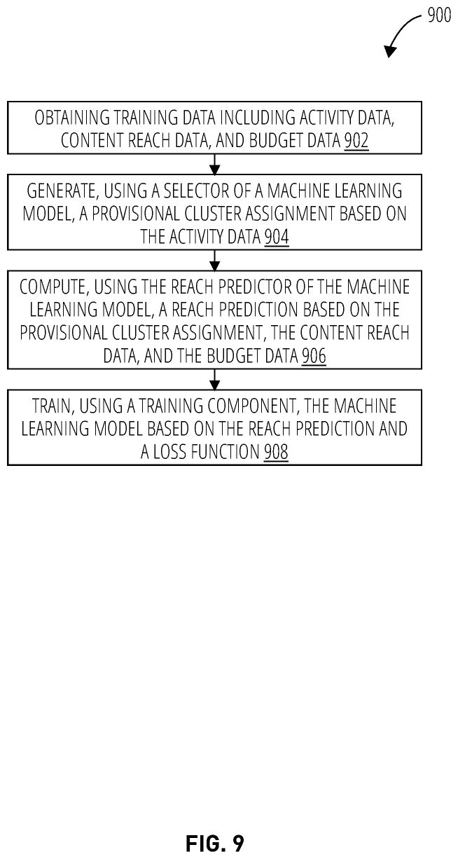

FIG. 9 illustrates a logic flow 900. Logic flow 700 describes a method for training a system for targeted content delivery. One or more aspects of the method include obtaining training data including activity data and content objective data; generating a provisional cluster assignment based on the activity data using a machine learning model; and training the machine learning model based on the cluster assignment, the content objective data, and budget data.

In block 902, logic flow 900 obtains training data including activity data, content objective data, and budget data. In block 904, logic flow 900 generates, using a selector of a machine learning model, a provisional cluster assignment based on the activity data. In block 906, logic flow 900 computes, using the reach predictor of the machine learning model, a reach prediction based on the provisional cluster assignment, the content objective data, and the budget data. In block 908, logic flow 900 trains, using a training component, the machine learning model based on the reach prediction and a loss function.

Some examples of the method, apparatus, non-transitory computer readable medium, and system further include computing a predicted reach based on the provisional cluster assignment. Some examples further include computing an objective loss based on the predicted reach and the content objective data, wherein the machine learning model is trained based on the objective loss. Some examples further include computing a predicted expenditure for delivering content to users represented by a set of static characteristics, and comparing the predicted expenditure to an allocated budget for a list of users in a corresponding cluster, and training the machine learning model based on this comparison.

Some examples of the method, apparatus, non-transitory computer readable medium, and system further include obtaining conversion data. Some examples further include computing a predicted conversion rate. Some examples further include computing a conversion loss based on the predicted conversion rate, wherein the machine learning model is trained based on the conversion loss.

Some examples of the method, apparatus, non-transitory computer readable medium, and system further include pre-training an encoder 308, a conversion predictor 314, and a selector 310 of the machine learning model in a first training phase. Some examples further include training an encoder 308, a selector 310, and a conversion predictor 314 of the machine learning model in a second training phase. Some examples further include training a mapping function 316 in a third training phase. Some examples further include training a selector 310, a conversion predictor 314, and an objective predictor 312 of the machine learning model in a fourth training phase.

Some examples of the method, apparatus, non-transitory computer readable medium, and system further include assigning a user to a user segment using the machine learning model. Some examples further include providing targeted content to the user based on the user segment. Some examples further include obtaining a conversion result for the user based on the targeted content. Some examples further include updating the machine learning model based on the conversion result.

Embodiments of a content delivery apparatus include a machine learning model with several subcomponents, such as the embodiments described with reference to FIG. 3 and FIG. 4. In some cases, the machine learning model is trained in one or more training phases such that its subcomponents are optimized to generate embeddings and to segment users such that content delivered to the segments reaches many users in the segment, and such that the segments maintain a high conversion rate during a customer journey. In this way, embodiments jointly optimize for conversion and content reach, and provide for the efficient delivery of content.

In some embodiments, the training includes a phase for pre-training the encoder 308 and the conversion predictor 314 and the selector 310, a phase for training the encoder 308, the selector 310 and the objective predictor 312, a phase for training the mapping function 316, and a phase for training the selector 310, conversion predictor 314, and objective predictor 312. Though these phases are described separately, according to various embodiments, each phase can occur simultaneously with other phases, separately from the other phases, or in some combination thereof.

FIG. 10 illustrates a training apparatus 1000. The training apparatus 1000 depicts a training device 1014 suitable to generate a trained ML model 116 for the inferencing device 604 of the system 600. In one embodiment, the training device 1014 executes various ML components 1010 to general the ML model 116 by training and testing the ML model 116.

As depicted in FIG. 10, the training device 1014 includes a processing circuitry 1016 and a set of ML components 1010 to support various AI/ML techniques, such as a data collector 1002, a model trainer 1004, a model evaluator 1006 and a model inferencer 1008.

In general, the data collector 1002 collects data 1012 from one or more data sources to use as training data for the ML model 630. The data collector 1002 collects different types of data 1012, such as text information, audio information, image information, video information, graphic information, and so forth. The model trainer 1004 receives as input the collected data and uses a portion of the collected data as test data for an AI/ML algorithm to train the ML model 630. The model evaluator 1006 evaluates and improves the trained ML model 630 using a portion of the collected data as test data to test the ML model 630. The model evaluator 1006 also uses feedback information from the deployed ML model 630. The model inferencer 1008 implements the trained ML model 630 to receive as input new unseen data, generate one or more inferences on the new data, and output a result such as an alert, a recommendation or other post-solution activity.

In one embodiment, the ML model 116 is trained using three training algorithms in different training phases. Operations for the three training algorithms are detailed below.

Algorithm 1 Pre-training
Algorithm 1 Pre-training

| | Input: Dataset [symbol] = {(xₜⁿ, yₜⁿ)ₜ₌₁^{τ}^{ⁿ}}ₙ₌₁^{N}, number of clusters K, learning rate η, mini-batch size n_{mb} |
|---|---|
| | Output: Model parameters {θ, ψ, ϕ}, initialized by Glorot-Uniform, embedding dictionary ε. |
| | Pre-train Encoder-Predictor |
| 1: | repeat |
| 2: | Sample mini-batch of n_{mb} samples |
| 3: | for n = 1 to n_{mb} do |
| 4: | Calculate ŷₜⁿ ← g_{ϕ}(f_{θ}(x_{1:t}n)) |
| 5: | $θ ← θ - η \frac{1}{{n}_{mb}} {\sum }_{n = 1}^{{n}_{mb}} {\sum }_{t = 1}^{{T}^{n}} {∇}_{θ} {l}_{1} ( {y}_{t}^{n} , {\hat{y}}_{t}^{n} ) , ϕ ← ϕ - η \frac{1}{{n}_{mb}} {\sum }_{n = 1}^{{n}_{mb}} {∇}_{ϕ} {l}_{1} ( {y}_{t}^{n} , {\hat{y}}_{t}^{n} )$ |
| 6: | until convergence |
| | Calculate embeddings dictionary ε and initial cluster assignments cₜⁿ |
| 7: | ε, {{cₜⁿ}ₜ₌₁^{τ}^{ⁿ})ₙ₌₁^{N} ← K-Means({{zₜⁿ}ₜ₌₁ⁿ^{_{mb}}}ₙ₌₁^{N}), where zₜⁿ = f_{θ}(x_{1:t}) |
| | Pre-train the Selector |
| 8: | repeat |
| 9: | Sample a minimbatch n_{mb} of data samples |
| 10: | for n = 1 . . . n_{mb} do |
| 11: | Calculate cluster assignment probability πₜⁿ ← h_{ψ} (f_{θ}(x_{1:t}) |
| 12: | $Update selector parameters , ψ ← ψ + η \frac{1}{{n}_{mb}} {\sum }_{n = 1}^{{n}_{mb}} {\sum }_{t = 1}^{{τ}^{n}} {\sum }_{k = 1}^{K} {c}_{t}^{n} ( k ) log {π}_{t}^{n} ( k )$ |
| 13: | until convergence |

Algorithm 2 Pseudo-code
Algorithm 2 Pseudo-code

| Pre-train Encoder-Predictor | |
|---|---|
| Initialize Cluster Centroid Embeddings | |
| Pre-train Selector | [symbol] Run Algorithm 1 |

| | |
|---|---|
| 1: | repeat |
| 2: | Sample mini-batch of n_{mb} samples |
| 3: | for n = 1 to n_{mb} do |
| 4: | Train Actor ← min [symbol] _{A}(θ, ϕ, ψ) |
| 5: | Train Critic ← min [symbol] _{C}(ϕ) |
| 6: | for n = 1 to n_{mb} do |
| 7: | Update embedding dictionary ← min [symbol] _{E}(ε) |
| 8: | until convergence |
| 9: | repeat |
| 10: | Sample mini-batch of n_{mb} samples |
| 11: | for n = 1 to n_{mb} do |
| 12: | Train Beh2Stat ← min [symbol] _{B}(ω) |
| 13: | until convergence |
| 14: | repeat |
| 15: | Sample mini-batch of n_{mb} samples |
| 16: | for n = 1 to n_{mb} do |
| 17: | Train Joint_Opt ← min [symbol] ₄(θ, ϕ, ψ, ω, δ) |
| 18: | Update embedding dictionary ← min [symbol] _{E}(ε) |
| 19: | until convergence |

Algorithm 3 Joint_Opt training
Algorithm 3 Joint_Opt training

| | |
|---|---|
| 1: | for each mini-batch in {(xₜⁿ, yₜⁿ)ₜ₌₁^{r}^{ⁿ}}ₙ₌₁ⁿ^{_{mb}} ~ [symbol] do |
| 2: | zₜⁿ ← f_{θ}(x_{1:t}ⁿ) |
| 3: | πₜⁿ ← h_{ψ}(zₜⁿ) |
| 4: | sample cluster assignment cₜⁿ ~ Cat(πₜⁿ)) |
| 5: | centroid embedding z̅ₜⁿ := ε(cₜⁿ) |
| 6: | y̅ₜⁿ ← g_{φ}(z̅ₜⁿ) |
| 7: | [symbol] ← b_{ω}(z̅ₜⁿ) |
| 8: | Aᵢⱼ ← υ_{δ}( [symbol] ) |
| 9: | Compute reach, R using (2) |
| 10: | Compute constraint, T using (5) |
| 11: | Update h_{ψ}, g_{φ}, and υ_{δ}, minimize [symbol] ₄(θ, ϕ, ψ, ω, δ) |

Pseudo-code of the model is given in Algorithm 2, and the joint optimization in Algorithm 3. An example for an ordered sequence of training phases needed for initialization and training includes: (1) a first training phase for pre-training the encoder 308, the conversion predictor 314, and the selector 310; (2) a second training phase for training actor entities (e.g., encoder 308, selector 310), a critic entity (e.g., conversion predictor 314), and user embeddings 404; (3) a third training phase for training the mapping function 316 (Beh2Stat); and a fourth training phase for training the selector 310, the conversion predictor 314, and the objective predictor 312. Embodiments are not limited to these examples of training phases and ordered sequence of training phases.

The model trainer 1004 implements algorithm 1 for pre-training and initialization of the ML model 116 as follows. The model trainer 1004 first pre-trains the encoder 308 and the conversion predictor 314 using a loss function as expressed in Equation (6) as follows:

$${ℒ}_{1} ( θ , ϕ ) = {𝔼}_{x , y \sim {p}_{XY}} [ - {\sum }_{t ∈ 𝒯} {l}_{1} ( {y}_{t} , {\hat{y}}_{t} ) ] \qquad ( 6 )$$

The ŷₜ=g_{ϕ}(f_{θ}(xₜ)) is the predicted conversion probability of a user and

$${l}_{1} ( {y}_{t} , {\hat{y}}_{t} ) = - {\sum }_{c ∈ \{ 0 , 1 \}} {y}_{t}^{c} log ( {\hat{y}}_{t}^{c} ) .$$

Second, the model trainer 1004 initializes the cluster embeddings using K-means on the representations zₜ⁽ⁿ⁾ for all n users and for all t that are obtained after pre-training the encoder 308. Third, the model trainer 1004 pre-trains the selector 310 on all zₜ⁽ⁿ⁾ and corresponding cluster assignments obtained from K-means.

Subsequently, the model trainer 1004 performing training by executing lines 1-8 in Algorithm 2 to perform an alternating minimization approach to alternate between training an Actor-Critic network and updating the embedding dictionary 406. Here the Actor is the (Encoder 308, Selector 310) pair of networks and the Critic is the Predictor network. The model trainer 1004 executes lines 9-13 in Algorithm 2 train the mapping function 316 network (Beh2Stat). Finally, the model trainer 1004 executes lines 14-19 using alternating minimization to alternate between maximizing the reach and updating the embedding dictionary 406.

The actor's loss is L_{A}(θ, ϕ, ψ)=L₁ (θ, ϕ, ψ)+αL₂ (θ, ϕ) which combines two losses with α as the hyperparameter. The loss term L₂ (θ, ψ) promotes sparse cluster assignment such that each user belonging to only one cluster with high probability. It is given by Equation (7) as follows:

$${ℒ}_{2} ( θ , ψ ) = {𝔼}_{x \sim {p}_{X}} [ - {\sum }_{t ∈ T} {\sum }_{k ∈ K} {π}_{t} ( k ) log {π}_{t} ( k ) ] \qquad ( 7 )$$

The loss term L₁ (θ, ϕ, ψ) promotes the prediction of cluster level outcomes y̅ₜ from the cluster centroid. It is the partial function obtained by fixing the embedding dictionary 406 E is the loss expression L₁ (θ, ϕ, ψ, E) given by Equation (8) as follows:

$${ℒ}_{1} ( θ , ϕ , ψ , ℰ ) = {𝔼}_{x , y \sim {p}_{XY}} [ - {\sum }_{t ∈ T} {𝔼}_{{c}_{t} \sim Cat ( {π}_{t} )} [ {l}_{1} ( {y}_{t} , {\tilde{y}}_{t} ) ] ] \qquad ( 8 )$$

The critic's loss is set to L_{C} (ϕ)=L₁ (θ, ϕ, ψ). Further, to promote well-separated cluster centroids in the embedding dictionary representation, the loss L_{E} (E)=L₁ (E)+βL₃ (E) is used to update the embedding dictionary, as expressed in Equation (9) as follows:

$${ℒ}_{3} ( ℰ ) = - {\sum }_{k \neq {k}^{′}} {l}_{1} ( {g}_{ϕ} ( e ( k ) , {g}_{ϕ} ( e ( {k}^{′} ) ) \qquad ( 9 )$$

For the reach maximization subject to budget constraints, the model trainer 1004 uses the known techniques of Barrier method and Augmented Lagrangian from constrained deterministic optimization to convert it to an equivalent unconstrained objective for Algorithm 3. These methods are fairly well understood for convex optimization. However, neural network training is a non-convex problem and in this setting, the methods employing Barriers or Augmented Lagrangians are not as well understood, despite being intuitive. The model trainer 1004 implements three formulations: (1) Slack Minimization with loss as set forth in Equation (10); (2) Barrier Method with loss as set forth in Equation (11); and (3) Augmented Lagrangian Method with loss as set forth in Equation (12), as follows:

$${ℒ}_{R} = \frac{1}{ln ( R )} + \frac{max ( {T}_{R} , 0 )}{w} \qquad ( 10 )$$

$${ℒ}_{R} = \frac{1}{ln ( R )} - \frac{log ( - {T}_{R} )}{w} \qquad ( 11 )$$

$${ℒ}_{R} = \frac{1}{ln ( R )} - \frac{λ {T}_{R}}{B} + \frac{μ}{2} {( \frac{{T}_{R}}{8} )}^{2} \qquad ( 12 )$$

The update rule is as follows:

$${λ}_{k} ← max ( {λ}_{k - 1} + μ * \frac{{T}_{R , k - 1}}{B} , 0 )$$

The k is iteration. Note that λ≥0 and the model trainer 1004 uses initialization μ←0.1, λ←0.1.

In one example implementation, including network parameters and hyperparameters used are as follows. The encoder 308 is a HAN, with the dimension of the hidden layer being 50. The predictor is a Multi-Layered Perceptron (MLP), with input zₜ (of dimension 50), two hidden layer with 50 perceptrons and an output layer of size 1. A dropout rate of 0.3 is used after the hidden layer. Hidden layers have ReLU activation and the output layer has sigmoid activation. Selector 310 is also an MLP with input zₜ, followed by hidden layer with 50 perceptrons, which uses ReLU activation and a dropout 0.3. The output layer is of size K, with softmax activation. The Encoder-Predictor, Selector, Actor and Critic are trained using Adam Optimizer with a learning rate of 0.001 on the aforementioned loss functions. The network weights and biases are initialized using “glorot uniform”. Batch size used is 128. Initialization iterations for pretraining the Encoder-Predictor is 1300 and that for pretraining the selector is 5000. Number of iterations for training actor, critic and embeddings is 1300, with an early stopping after 100 epochs, based on minimum value of L₁, L₂ and L₃ obtained on validation data within previous 15 iterations. Beh2Stat is an MLP with input zₜ (of dimension 50), four hidden layer with 500 perceptrons and the output layer uses Softmax activation to yield probabilities over the static features. It is trained for the same number of iterations as actor-critic, using Adam Optimizer with a learning rate of 0.005. The joint optimization model (Algorithm 3) is trained to update the parameters of Selector, Predictor and MLP vδ (S), with the input as static features and output as mediums. It is trained for 2000 iterations, with an early stopping after 100 epochs, based on minimum value of L₄ obtained on validation data within previous 15 iterations.

FIG. 11 illustrates convergence plots 1102 for losses L₁, L₂, L₃, and L₄. Depicting training and validation convergence plots for Augmented Lagrangian Method on an experimental dataset, the four convergence plots 1102 show good convergence for the four losses.

Experiments were designed around joint optimization of two goals: (i) strong predictive conversion performance for behavior segments; and (ii) achieve high reach relative to spend, subject to budget constraint. In direct media spend, one can think of reach as corresponding to pay-per-click, used by businesses to pay for messages they send to the targeted segments. The experiments test these goals and are described next. Two SOTA baselines (DISC) plus five proposed Delivery-Aware-Discovery (DAD) models are presented below. For baselines, DISC-UC is a first baseline, based on a behavioral segmentation objective, is the discovery focused SOTA baseline, not delivery-optimized, since delivery-optimized-discovery is not available. Here, the spend is unconstrained (UC) by the budget. DISC-BC is a second baseline, where the discovery is focused SOTA baseline, not delivery-optimized, but the spend is budget constrained (BC). The model trainer 1004 trains Step 1 and Step 2 of the network to obtain K segments, and skip Step 3 reach maximization. Reach is computed for each segment, for each medium, and assign each segment to a medium giving the highest reach value for it. This process is repeated until no budget is left over.

Proposed models include: DAD-CSSE: Cluster Specific MSE, Equation (3); DAD-CASE: Cluster Agnostic MSE, Equation (4); DAD-SMIN: Slack Minimization, Equation (10); DAD-BARR: Barrier, Equation (11); and DAD-ALM: Augmented Lagrangian, Equation (12).

Performance Metrics are used to evaluate against the ground truth of outcome, conversion, and spend efficiency to increase reach. Two new metrics are introduced which combine conversion accuracy, spend, and budget to give new insights about efficiency and effectiveness of segmentation and delivery.

Consistent with the first goal of strong predictive conversion for behavior segments, the performance metric is AUROCy̅, for which higher values are better.

Another metric, Spend per Unit Reach, is a spend metric comparable across models including baselines is the resource consumption per unit objective. Since delivery-optimized-delivery is not available in the two DISC baselines an overall spend metric is unfair to baselines. However, resource consumption per unit objective can be used since both reach and spend are affected in a comparable way for each model. Here, lower values are better.

Another metric, Within % Budget, expresses the optimal spend relative to the budget and applies to all five proposed DAD models. Since the DISC-UC baseline's delivery has no budget constraint, the metric is undefined for DISC-UC. The DISC-BC baseline is budget constrained and this metric applies. Here, a tighter interval around zero is better since it indicates closeness to the budget.

Another metric, Effective Spend, is a new contribution. This metric, capturing ‘effectiveness of spend,’ combines the two metrics AUROC y̅ and Spend per Unit Reach, used respectively for the two goals of high predictive target accuracy and low resource consumption per unit objective h, into a composite scalar metric. By combining two metrics, a scalar metric represents the combined goal. This is defined as Effective Spend=resource consumption per unit objective h/AUROC y̅. For the numerator, lower is better, while for the denominator, higher is better. Put together, for Effective Spend, lower values are better.

Another metric, Reach Efficiency-Effectiveness or Reach Effc-Effe, contributes another new metric, this is the second composite, scalar metric which captures both the ‘efficiency’ and ‘effectiveness’ of reach. Note that model trainer 1004 seeks to maximize reach, subject to a budget, defined as: Reach Effc−Effe=(Reach/Spend as Proportion of Budget)*(AUROC y̅). The term in the first parenthesis represents reach efficiency, making reach-efficiency increase (decrease) when the denominator is less (more) than 1. The term in the second parenthesis stands for accuracy of prediction, and thus combined with the first term, provide a succinct representation of both the efficiency of budget spend to maximize reach, and the effectiveness in achieving the other goal of high performance in predictive target accuracy. The DISC-UC baseline's delivery has no budget constraint; this metric is undefined for DISC-UC. Here, higher values are better.

Segmentation of users is highly desirable by a firm as emphasized in both industry and academia since users' online behaviors are very predictive of outcomes such as conversion. Firms send different offers, messages, communications to different segments. The obstacle in delivering messages on media channels lies in reaching these behavioral segments on media. On a medium, only a proportion of a behavior segment can be matched, and of those matched only a fraction sees/clicks on a message. Moreover, on a medium, users are defined by their static characteristics, but not by their online interactions with the firm, which only the firm knows, but the media do not. For segmentation to be useful, delivery ought to be considered simultaneously, and not sequentially after segmentation. Extant work on segmentation of user segments ignore the need for this simultaneity between segmentation and delivery. Embodiments offer an approach to fill this technology gap. Extensive experiments on two datasets—proprietary and public (Google Analytics)—find strong support for this approach. Moreover, sensitivity experiments on Google data, by varying the hyperparameter, number of segments, affirm those findings that our approach achieves high, improved performance on Spend and Reach metrics, while achieving equally good predictive conversion performance AUROC, compared to two SOTA baselines. Ablation studies, including sensitivity of ablation to number of segments, further justify the value of our proposed network to address this joint delivery-aware-segment optimization challenge at hand.

Evaluation results for performance of the mapping function 316 (Beh2Stat), is shown in TABLE 1 below.

TABLE 1

ACCURACY

| Static Characteristics | # Classes | Beh2Stat | Random |
|---|---|---|---|
| Country | 6 | 0.58 | 0.17 |
| Source | 2 | 0.86 | 0.5 |
| Member | 3 | 0.53 | 0.33 |
| Browser | 6 | 0.51 | 0.17 |
| Operating System (OS) | 6 | 0.51 | 0.17 |

It is worthy to note that joint optimization works when the cost of a message sent to a user is known and not necessarily an outcome of bidding.

An exemplary AI/ML architecture for the ML components 1010 is described in more detail with reference to FIG. 12.

FIG. 12 illustrates a training system 1200 suitable for use by the training device 1014 to generate the ML model 630 for deployment by the inferencing device 604. The training system 1200 is an example of a system suitable for implementing various AI techniques and/or ML techniques to perform various inferencing tasks on behalf of the various devices of the system 600.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the training system 1200 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 630, evaluate performance of the trained ML model 630, and deploy the tested ML model 630 as the trained ML model 630 in a production environment, and continuously monitor and maintain it.

The ML model 630 is a mathematical construct used to predict outcomes based on a set of input data. The ML model 630 is trained using large volumes of training data 1226, and it can recognize patterns and trends in the training data 1226 to make accurate predictions. The ML model 630 is derived from an ML algorithm 1224 (e.g., a neural network, decision tree, support vector machine, etc.). A data set is fed into the ML algorithm 1224 which trains an ML model 630 to “learn” a function that produces mappings between a set of inputs and a set of outputs with a reasonably high accuracy. Given a sufficiently large enough set of inputs and outputs, the ML algorithm 1224 finds the function for a given task. This function may even be able to produce the correct output for input that it has not seen during training. A data scientist prepares the mappings, selects and tunes the ML algorithm 1224, and evaluates the resulting model performance. Once the ML logic 628 is sufficiently accurate on test data, it can be deployed for production use.

The ML algorithm 1224 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1224 of the training system 1200 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 12, the training system 1200 includes a set of data sources 1202 to source data 1204 for the training system 1200. Data sources 1202 may comprise any device capable generating, processing, storing or managing data 1204 suitable for a ML system. Examples of data sources 1202 include without limitation databases, web scraping, sensors and Internet of Things (IoT) devices, image and video cameras, audio devices, text generators, publicly available databases, private databases, and many other data sources 1202. The data sources 1202 may be remote from the training system 1200 and accessed via a network, local to the training system 1200 an accessed via a network interface, or may be a combination of local and remote data sources 1202.

The data sources 1202 source difference types of data 1204. By way of example and not limitation, the data 1204 includes structured data from relational databases, such as customer profiles, transaction histories, or product inventories. The data 1204 includes unstructured data from websites such as customer reviews, news articles, social media posts, or product specifications. The data 1204 includes data from temperature sensors, motion detectors, and smart home appliances. The data 1204 includes image data from medical images, security footage, or satellite images. The data 1204 includes audio data from speech recognition, music recognition, or call centers. The data 1204 includes text data from emails, chat logs, customer feedback, news articles or social media posts. The data 1204 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1204 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1202 are communicatively coupled to a data collector 1002. The data collector 1002 gathers relevant data 1204 from the data sources 1202. Once collected, the data collector 1002 may use a pre-processor 1206 to make the data 1204 suitable for analysis. This involves data cleaning, transformation, and feature engineering. Data preprocessing is a critical step in ML as it directly impacts the accuracy and effectiveness of the ML model 630. The pre-processor 1206 receives the data 1204 as input, processes the data 1204, and outputs pre-processed data 1216 for storage in a database 1208. Examples for the database 1208 includes a hard drive, solid state storage, and/or random access memory (RAM).

The data collector 1002 is communicatively coupled to a model trainer 1004. The model trainer 1004 performs AI/ML model training, validation, and testing which may generate model performance metrics as part of the model testing procedure. The model trainer 1004 receives the pre-processed data 1216 as input 1210 or via the database 1208. The model trainer 1004 implements a suitable ML algorithm 1224 to train an ML model 630 on a set of training data 1226 from the pre-processed data 1216. The training process involves feeding the pre-processed data 1216 into the ML algorithm 1224 to produce or optimize an ML model 630. The training process adjusts its parameters until it achieves an initial level of satisfactory performance.

The model trainer 1004 is communicatively coupled to a model evaluator 1006. After an ML model 630 is trained, the ML model 630 needs to be evaluated to assess its performance. This is done using various metrics such as accuracy, precision, recall, and F1 score. The model trainer 1004 outputs the ML model 630, which is received as input 1210 or from the database 1208. The model evaluator 1006 receives the ML model 630 as input 1212, and it initiates an evaluation process to measure performance of the ML model 630. The evaluation process includes providing feedback 1218 to the model trainer 1004. The model trainer 1004 re-trains the ML model 630 to improve performance in an iterative manner.

The model evaluator 1006 is communicatively coupled to a model inferencer 1008. The model inferencer 1008 provides AI/ML model inference output (e.g., inferences, predictions or decisions). Once the ML model 630 is trained and evaluated, it is deployed in a production environment where it is used to make predictions on new data. The model inferencer 1008 receives the evaluated ML model 630 as input 1214. The model inferencer 1008 uses the evaluated ML model 630 to produce insights or predictions on real data, which is deployed as a final production ML model 630. The inference output of the ML model 630 is use case specific. The model inferencer 1008 also performs model monitoring and maintenance, which involves continuously monitoring performance of the ML model 630 in the production environment and making any necessary updates or modifications to maintain its accuracy and effectiveness. The model inferencer 1008 provides feedback 1218 to the data collector 1002 to train or re-train the ML model 630. The feedback 1218 includes model performance feedback information, which is used for monitoring and improving performance of the ML model 630.

Some or all of the model inferencer 1008 is implemented by various actors 1222 in the training system 1200, including the ML model 630 of the inferencing device 604, for example. The actors 1222 use the deployed ML model 630 on new data to make inferences or predictions for a given task, and output an insight 1232. The actors 1222 implement the model inferencer 1008 locally, or remotely receives outputs from the model inferencer 1008 in a distributed computing manner. The actors 1222 trigger actions directed to other entities or to itself. The actors 1222 provide feedback 1220 to the data collector 1002 via the model inferencer 1008. The feedback 1220 comprise data needed to derive training data, inference data or to monitor the performance of the ML model 630 and its impact to the network through updating of key performance indicators (KPIs) and performance counters.

As previously described with reference to FIGS. 1, 2, the systems 600, 1000 implement some or all of the training system 1200 to support various use cases and solutions for various AI/ML tasks. In various embodiments, the training device 1014 of the training apparatus 1000 uses the training system 1200 to generate and train the ML model 630 for use by the inferencing device 604 for the system 600. In one embodiment, for example, the training device 1014 may train the ML model 630 as a neural network, as described in more detail with reference to FIG. 13. Other use cases and solutions for AI/ML are possible as well, and embodiments are not limited in this context.

FIG. 13 illustrates an embodiment of an artificial neural network 1300. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1300 comprises multiple node layers, containing an input layer 1326, one or more hidden layers 1328, and an output layer 1330. Each layer comprises one or more nodes, such as nodes 1302 to 1324. As depicted in FIG. 13, for example, the input layer 1326 has nodes 1302, 1304. The artificial neural network 1300 has two hidden layers 1328, with a first hidden layer having nodes 1306, 1308, 1310 and 1312, and a second hidden layer having nodes 1314, 1316, 1318 and 1320. The artificial neural network 1300 has an output layer 1330 with nodes 1322, 1324. Each node 1302 to 1324 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1300 relies on training data 1226 to learn and improve accuracy over time. However, once the artificial neural network 1300 is fine-tuned for accuracy, and tested on testing data 1228, the artificial neural network 1300 is ready to classify and cluster new data 1230 at a high velocity. Tasks in speech recognition or image recognition can take minutes versus hours when compared to the manual identification by human experts.

Each individual node 1302 to 424 is a linear regression model, composed of input data, weights, a bias (or threshold), and an output. Once an input layer 1326 is determined, a set of weights 1332 are assigned. The weights 1332 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1300 as a feedforward network.

In one embodiment, the artificial neural network 1300 leverages sigmoid neurons, which are distinguished by having values between 0 and 1. Since the artificial neural network 1300 behaves similarly to a decision tree, cascading data from one node to another, having x values between 0 and I will reduce the impact of any given change of a single variable on the output of any given node, and subsequently, the output of the artificial neural network 1300.

The artificial neural network 1300 has many practical use cases, like image recognition, speech recognition, text recognition or classification. The artificial neural network 1300 leverages supervised learning, or labeled datasets, to train the algorithm. As the model is trained, its accuracy is measured using a cost (or loss) function. This is also commonly referred to as the mean squared error (MSE).

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1334 of the model adjust to gradually converge at the minimum.

In one embodiment, the artificial neural network 1300 is feedforward, meaning it flows in one direction only, from input to output. In one embodiment, the artificial neural network 1300 uses backpropagation. Backpropagation is when the artificial neural network 1300 moves in the opposite direction from output to input. Backpropagation allows calculation and attribution of errors associated with each neuron 1302 to 1324, thereby allowing adjustment to fit the parameters 1334 of the ML model 630 appropriately.

The artificial neural network 1300 is implemented as different neural networks depending on a given task. Neural networks are classified into different types, which are used for different purposes. In one embodiment, the artificial neural network 1300 is implemented as a feedforward neural network, or multi-layer perceptrons (MLPs), comprised of an input layer 1326, hidden layers 1328, and an output layer 1330. While these neural networks are also commonly referred to as MLPs, they are actually comprised of sigmoid neurons, not perceptrons, as most real-world problems are nonlinear. Trained data 1204 usually is fed into these models to train them, and they are the foundation for computer vision, natural language processing, and other neural networks. In one embodiment, the artificial neural network 1300 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1300 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1300 is implemented as any type of neural network suitable for a given operational task of system 600, and the MLP, CNN, and RNN are merely a few examples. Embodiments are not limited in this context.

The artificial neural network 1300 includes a set of associated parameters 1334. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1300 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1336. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

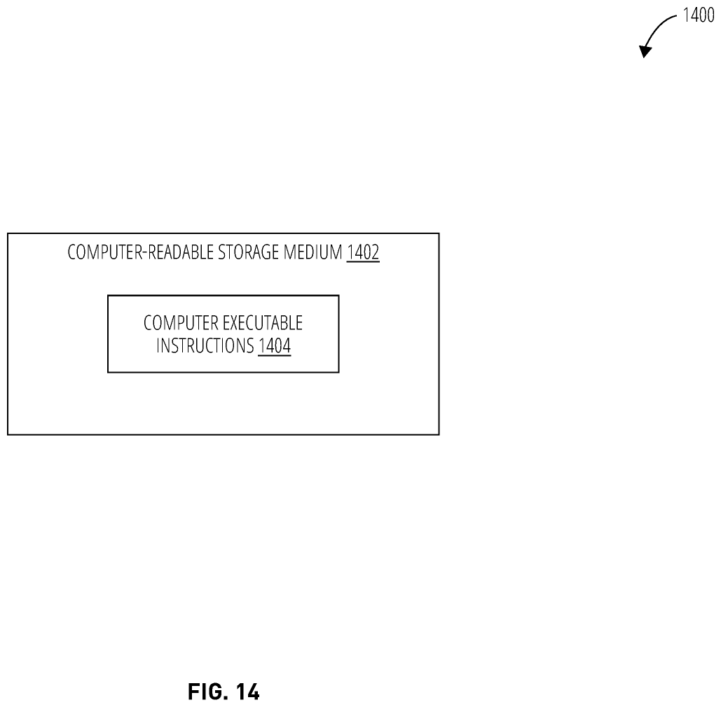

FIG. 14 illustrates an apparatus 1400. Apparatus 1400 comprises any non-transitory computer-readable storage medium 1402 or machine-readable storage medium, such as an optical, magnetic or semiconductor storage medium. In various embodiments, apparatus 1400 comprises an article of manufacture or a product. In some embodiments, the computer-readable storage medium 1402 stores computer executable instructions with which one or more processing devices or processing circuitry can execute. For example, computer executable instructions 1404 includes instructions to implement operations described with respect to any logic flows described herein. Examples of computer-readable storage medium 1402 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1404 include any suitable type of code, such as source code, compiled code, interpreted code, executable code, static code, dynamic code, object-oriented code, visual code, and the like.

FIG. 15 illustrates an embodiment of a computing architecture 1500. Computing architecture 1500 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1500 has a single processor with one core or more than one processor. Note that the term “processor” refers to a processor with a single core or a processor package with multiple processor cores. In at least one embodiment, the computing architecture 1500 is representative of the components of the system 600. More generally, the computing architecture 1500 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1500. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 15, computing architecture 1500 comprises a system-on-chip (SoC) 1502 for mounting platform components. System-on-chip (SoC) 1502 is a point-to-point (P2P) interconnect platform that includes a first processor 1504 and a second processor 1506 coupled via a point-to-point interconnect 1570 such as an Ultra Path Interconnect (UPI). In other embodiments, the computing architecture 1500 is another bus architecture, such as a multi-drop bus. Furthermore, each of processor 1504 and processor 1506 are processor packages with multiple processor cores including core(s) 1508 and core(s) 1510, respectively. While the computing architecture 1500 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1504 and chipset 1532. Some platforms include additional components and some platforms include sockets to mount the processors and/or the chipset. Furthermore, some platforms do not have sockets (e.g. SoC, or the like). Although depicted as a SoC 1502, one or more of the components of the SoC 1502 are included in a single die package, a multi-chip module (MCM), a multi-die package, a chiplet, a bridge, and/or an interposer. Therefore, embodiments are not limited to a SoC.

The processor 1504 and processor 1506 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1504 and/or processor 1506. Additionally, the processor 1504 need not be identical to processor 1506.

Processor 1504 includes an integrated memory controller (IMC) 1520 and point-to-point (P2P) interface 1524 and P2P interface 1528. Similarly, the processor 1506 includes an IMC 1522 as well as P2P interface 1526 and P2P interface 1530. IMC 1520 and IMC 1522 couple the processor 1504 and processor 1506, respectively, to respective memories (e.g., memory 1516 and memory 1518). Memory 1516 and memory 1518 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1516 and the memory 1518 locally attach to the respective processors (i.e., processor 1504 and processor 1506). In other embodiments, the main memory couple with the processors via a bus and shared memory hub. Processor 1504 includes registers 1512 and processor 1506 includes registers 1514.

Computing architecture 1500 includes chipset 1532 coupled to processor 1504 and processor 1506. Furthermore, chipset 1532 are coupled to storage device 1550, for example, via an interface (I/F) 1538. The I/F 1538 may be, for example, a Peripheral Component Interconnect-enhanced (PCIe) interface, a Compute Express Link® (CXL) interface, or a Universal Chiplet Interconnect Express (UCIe) interface. Storage device 1550 stores instructions executable by circuitry of computing architecture 1500 (e.g., processor 1504, processor 1506, GPU 1548, accelerator 1554, vision processing unit 1556, or the like). For example, storage device 1550 can store instructions for the client device 602, the client device 606, the inferencing device 604, the training device 1014, or the like.

Processor 1504 couples to the chipset 1532 via P2P interface 1528 and P2P 1534 while processor 1506 couples to the chipset 1532 via P2P interface 1530 and P2P 1536. Direct media interface (DMI) 1576 and DMI 1578 couple the P2P interface 1528 and the P2P 1534 and the P2P interface 1530 and P2P 1536, respectively. DMI 1576 and DMI 1578 is a high-speed interconnect that facilitates, e.g., eight Giga Transfers per second (GT/s) such as DMI 3.0. In other embodiments, the processor 1504 and processor 1506 interconnect via a bus.

The chipset 1532 comprises a controller hub such as a platform controller hub (PCH). The chipset 1532 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1532 comprises more than one controller hub such as a chipset with a memory controller hub, a graphics controller hub, and an input/output (I/O) controller hub.

In the depicted example, chipset 1532 couples with a trusted platform module (TPM) 1544 and UEFI, BIOS, FLASH circuitry 1546 via I/F 1542. The TPM 1544 is a dedicated microcontroller designed to secure hardware by integrating cryptographic keys into devices. The UEFI, BIOS, FLASH circuitry 1546 may provide pre-boot code. The I/F 1542 may also be coupled to a network interface circuit (NIC) 1580 for connections off-chip.

Furthermore, chipset 1532 includes the I/F 1538 to couple chipset 1532 with a high-performance graphics engine, such as, graphics processing circuitry or a graphics processing unit (GPU) 1548. In other embodiments, the computing architecture 1500 includes a flexible display interface (FDI) (not shown) between the processor 1504 and/or the processor 1506 and the chipset 1532. The FDI interconnects a graphics processor core in one or more of processor 1504 and/or processor 1506 with the chipset 1532.

The computing architecture 1500 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1554 and/or vision processing unit 1556 are coupled to chipset 1532 via I/F 1538. The accelerator 1554 is representative of any type of accelerator device (e.g., a data streaming accelerator, cryptographic accelerator, cryptographic co-processor, an offload engine, etc.). One example of an accelerator 1554 is the Intel® Data Streaming Accelerator (DSA). The accelerator 1554 is a device including circuitry to accelerate copy operations, data encryption, hash value computation, data comparison operations (including comparison of data in memory 1516 and/or memory 1518), and/or data compression. Examples for the accelerator 1554 include a USB device, PCI device, PCIe device, CXL device, UCIe device, and/or an SPI device. The accelerator 1554 also includes circuitry arranged to execute machine learning (ML) related operations (e.g., training, inference, etc.) for ML models. Generally, the accelerator 1554 is specially designed to perform computationally intensive operations, such as hash value computations, comparison operations, cryptographic operations, and/or compression operations, in a manner that is more efficient than when performed by the processor 1504 or processor 1506. Because the load of the computing architecture 1500 includes hash value computations, comparison operations, cryptographic operations, and/or compression operations, the accelerator 1554 greatly increases performance of the computing architecture 1500 for these operations.

The accelerator 1554 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1554. For example, the accelerator 1554 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1554 via a non-posted write (e.g., a deferred memory write (DMWr)). One example of an instruction that atomically submits a work descriptor to the shared work queue of the accelerator 1554 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1554. The dedicated work queue may accept job submissions via commands such as the movdir64b instruction.

Various I/O devices 1560 and display 1552 couple to the bus 1572, along with a bus bridge 1558 which couples the bus 1572 to a second bus 1574 and an I/F 1540 that connects the bus 1572 with the chipset 1532. In one embodiment, the second bus 1574 is a low pin count (LPC) bus. Various input/output (I/O) devices couple to the second bus 1574 including, for example, a keyboard 1562, a mouse 1564 and communication devices 1566.

Furthermore, an audio I/O 1568 couples to second bus 1574. Many of the I/O devices 1560 and communication devices 1566 reside on the system-on-chip (SoC) 1502 while the keyboard 1562 and the mouse 1564 are add-on peripherals. In other embodiments, some or all the I/O devices 1560 and communication devices 1566 are add-on peripherals and do not reside on the system-on-chip (SoC) 1502.

FIG. 16 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 16, the communications architecture 1600 includes one or more clients 1602 and servers 1604. The clients 1602 and the servers 1604 are operatively connected to one or more respective client data stores 1608 and server data stores 1610 that can be employed to store information local to the respective clients 1602 and servers 1604, such as cookies and/or associated contextual information.

The clients 1602 and the servers 1604 communicate information between each other using a communication framework 1606. The communication framework 1606 implements any well-known communications techniques and protocols. The communication framework 1606 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1606 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/600/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1602 and the servers 1604. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What is claimed is:

1. A method, comprising:
obtaining activity data from a user device associated with a user;
selecting, using a selector of a machine learning model, a user segment for the user based on the activity data;
mapping, using a mapping function of the machine learning model, the activity data for the user segment to features defined by multiple media channels, each media channel assigned a resource component;
generating, using an objective predictor of the machine learning model, an objective prediction for the user segment based on the features and resource components of the media channels, the objective prediction identifying a media channel from the multiple media channels with a composite scalar metric above a defined threshold; and
providing content to the user device via the media channel.

2. The method of claim 1, wherein the composite scalar metric comprises an effective resource consumption metric that combines a first metric representing predictive target accuracy and a second metric representing resource consumption per unit objective.

3. The method of claim 1, wherein the composite scalar metric comprises an efficiency-effectiveness metric that combines a first metric representing reach-efficiency and a second metric representing accuracy of prediction.

4. The method of claim 1, comprising generating, using a conversion predictor of the machine learning model, a conversion prediction for the user segment using the machine learning model, wherein the content is provided based on the conversion prediction.

5. The method of claim 1, comprising encoding, using an encoder of the machine learning model, the activity data for the user to obtain a user embedding for the user, the user embedding to comprise a behavioral embedding.

6. The method of claim 5, wherein the machine learning model is trained using content objective data and resource data.

7. The method of claim 1, comprising generating a targeted content element based on the user segment, wherein the content includes the targeted content element.

8. The method of claim 1, comprising presenting the content on a graphical user interface (GUI) of an electronic display of a client device.

9. A non-transitory computer-readable medium storing executable instructions, which when executed by one or more processing devices, cause the one or more processing devices to perform operations comprising:
obtaining training data including activity data, content objective data, and resource data;
generating, using a selector of a machine learning model, a provisional cluster assignment based on the activity data;
computing, using an objective predictor of the machine learning model, an objective prediction based on the provisional cluster assignment, the content objective data, and the resource data; and
training, using a training component, the machine learning model based on the objective prediction and a loss function.

10. The computer-readable medium of claim 9, comprising instructions that cause the one or more processing devices to perform operations comprising computing, using the training component, an objective loss based on the objective prediction and the content objective data, wherein the machine learning model is trained based on the objective loss.

11. The computer-readable medium of claim 9, comprising instructions that cause the one or more processing devices to perform operations comprising:
computing a predicted expenditure for delivering content to users represented by a set of static characteristics based on the resource data;
comparing the predicted expenditure to an allocated budget for a list of users in a corresponding cluster; and
training the machine learning model based on the comparison.

12. The computer-readable medium of claim 9, comprising instructions that cause the one or more processing devices to perform operations comprising:
obtaining conversion data;
computing, using a conversion predictor of the machine learning model, a predicted conversion rate; and
computing, using the training component, a conversion loss based on the predicted conversion rate, wherein the machine learning model is trained based on the conversion loss.

13. The computer-readable medium of claim 9, comprising instructions that cause the one or more processing devices to perform operations comprising:
pre-training an encoder, a conversion predictor, and a selector of the machine learning model in a first training phase;
training the encoder, the selector, and the conversion predictor of the machine learning model in a second training phase;
training a mapping function of the machine learning model in a third training phase; and
training the selector, the conversion predictor, and an objective predictor of the machine learning model in a fourth training phase.

14. The computer-readable medium of claim 9, comprising instructions that cause the one or more processing devices to perform operations comprising:
assigning, using the selector of the machine learning model, a user to a user segment;
providing, via a user interface, targeted content to the user based on the user segment;
obtaining, using a conversion predictor of the machine learning model, a conversion result for the user based on the targeted content; and
updating, using a training component, the machine learning model based on the conversion result.

15. A system, comprising:
a memory component; and
one or more processing devices coupled to the memory component, the one or more processing devices to perform operations comprising:
obtaining activity data from a user device associated with a user;
selecting, using a selector of a machine learning model, a user segment for the user based on the activity data;
mapping, using a mapping function of the machine learning model, the activity data for the user segment to features defined by multiple media channels, each media channel assigned a resource component;
generating, using an objective predictor of the machine learning model, an objective prediction for the user segment based on the features and resource components of the media channels, the objective prediction identifying a media channel from the multiple media channels with a composite scalar metric above a defined threshold; and
providing content to the user device via the media channel.

16. The system of claim 15, wherein the composite scalar metric comprises an effective resource consumption metric that combines a first metric representing predictive target accuracy and a second metric representing resource consumption per unit objective.

17. The system of claim 15, wherein the composite scalar metric comprises an efficiency-effectiveness metric that combines a first metric representing reach-efficiency and a second metric representing accuracy of prediction.

18. The system of claim 15, the one or more processing devices to perform operations comprising generating, using a conversion predictor of the machine learning model, a conversion prediction for the user segment using the machine learning model, wherein the content is provided based on the conversion prediction.

19. The method of claim 15, the one or more processing devices to perform operations comprising encoding, using an encoder of the machine learning model, the activity data for the user to obtain a user embedding for the user, the user embedding to comprise a behavioral embedding.

20. The method of claim 19, wherein the encoder of the machine learning model is a hierarchical attention network (HAN) encoder, the HAN encoder to encode the activity data for the user within a session to a session-level vector and the session-level vector to the user embedding for the user.
